(19) United States
(12) Patent Application Publication
(10) Pub. No.: US 2013/0275174 A1
(43) Pub. Date: Oct. 17, 2013

(54) MOBILE AND/OR CLOUD BASED TOOL FOR ENABLING ACCURATE INFORMATION OF NEW AND RETROFIT PROJECTS

(71) Applicant: Lutron Electronics Co., Inc., Coopersburg, PA (US)

(72) Inventors: David Bennett, Bethlehem, PA (US); Christopher Buck, Bethlehem, PA (US); Gerard Darville, Macungie, PA (US); Hagen Denton, Royersford, PA (US); Mark Law, Bethlehem, PA (US); Brent Protzman, Easton, PA (US)

(21) Appl. No.: 13/801,459

(22) Filed: Mar. 13, 2013

Related U.S. Application Data
(60) Provisional application No. 61/610,330, filed on Mar. 13, 2012.
(60) Provisional application No. 61/742,438, filed on Aug. 10, 2012.
(60) Provisional application No. 61/773,075, filed on Mar. 5, 2013.

(51) Int. Cl. G06Q 50/08; G06F 17/50

(52) U.S. Cl. CPC G06Q 50/08; G06F 17/5004
USPC 705/7.23

(57) ABSTRACT

A real-time, mobile, energy savings and cost estimation tool may be provided. The energy savings and cost estimation tool may be implemented on a mobile electronic device, such as, but not limited to a laptop computer, tablet, or a smart phone, for example. A user may create a project and define project information using the energy savings and cost estimation tool while at the project site. For example, the user may discuss the project with a potential customer, ask questions about the project to be created or retrofitted, walk around the project site, and enter the project information into the energy savings and cost estimation tool. Using the project information gathered, the energy savings and cost estimation tool may provide real-time feedback, such as an energy usage audit, an energy usage solution design, an energy analysis, and/or a return on investment (ROI) analysis for the project, to the user.

### CROSS-REFERENCE TO RELATED APPLICATIONS

This application claims the benefit of Provisional U.S. Patent Application No. 61/610,330, filed Mar. 13, 2012, Provisional U.S. Patent Application No. 61/742,438, filed Aug. 10, 2012, and Provisional U.S. Patent Application No. 61/773,075, filed Mar. 5, 2013, the contents of which are hereby incorporated by reference herein.

### BACKGROUND

An owner of a project site may ask for a supplier to perform an energy usage audit, an energy usage solution design, an energy analysis, and/or a return on investment (ROI) analysis for their project. The project may be a retrofit project or a new construction project, for example. A new construction project may relate to a project site that includes one or more buildings that do not currently have any electrical loads or load control devices. A retrofit project may relate to a project site that already has electrical loads or load control devices installed, but the existing electrical loads or load control devices may be inefficient, may have limited functionality, and may be in need of updating.

The owner may ask a load control supplier to perform a lighting control audit, for example, to assess the current energy usage of the lighting and lighting controls of a project site. The supplier may be asked to perform a lighting solution design, for example, to propose new, more efficient lighting and lighting controls for the project site. The supplier may be asked to perform an energy analysis of the project site, for example, by comparing the existing energy usage of the existing lighting and lighting controls to the proposed energy usage of the lighting control solution. The supplier may be asked to perform a ROI analysis, for example, to measure the efficiency of the cost of the lighting solution over time. The supplier may generate a proposal that includes one or more of the lighting control audit, the lighting solution, the energy analysis, and/or the ROI analysis for the project site.

In order to create the proposal, the supplier may be required to gather detailed information regarding the project site, for example, by walking around the project site with technical instruments, assessing and measuring project characteristics, and gathering energy usage information. To gather energy usage information, the supplier may have to utilize equipment that reads and registers energy usage over an extended period of time, such as a year, for example. After gathering the required information, the supplier may be required to perform additional research and calculate the proposal using multiple complex formulas. Therefore, performing a lighting control audit, a lighting solution design, an energy analysis, and/or a return on investment (ROI) analysis for a project may require the acquisition of detailed information using technical instruments, along with the computation of complex formulas. Thus, generating a proposal for such an audit, design, or analysis may be complicated, time consuming, and highly prone to human errors.

### SUMMARY

As disclosed herein, a real-time, mobile, energy savings and cost estimation tool for an electronic device may be provided. The energy savings and cost estimation tool may be implemented on a mobile electronic device, such as, but not limited to a laptop computer, tablet, or a smart phone, for example. The energy savings and cost estimation tool may be a mobile application that resides on the mobile device. A user may create a project and enter project information into the energy savings and cost estimation tool while at a project site. For example, the user may discuss the project and/or proposal with a potential customer, ask questions about the project to be created or retrofitted, walk around the project site, and enter the project information into the energy savings and cost estimation tool. Using the project information gathered, the energy savings and cost estimation tool may provide real-time feedback, such as a solution, for example. The solution may include one or more of a bill of material (BOM) for the project, a cost estimate for the project, an estimate on different return on investment metrics for the project, energy savings of the project, etc. The solution may be displayed or delivered to a customer, for example, while the user is still at the project site. Further, after providing a solution to the user, additional information may be entered into the energy savings and cost estimation tool and an updated solution may be provided. Thus, the energy savings and cost estimation tool may provide solutions to the customer that may be updated dynamically.

An energy savings and cost estimation tool may be configured to receive high level variables relating to a project, draw from a rich database of information, and generate a solution, such as a retrofit lighting solution, for a customer. The high level variables may include one or more of a project type, a total number of buildings, a total yearly operating hours of the building(s) of the project, a number of floors (e.g., per building), a number of rooms (e.g., per floor and/or per building), a size of the rooms, whether the rooms have windows, number of zones per room, existing fixtures, controls, and sensors (e.g., per building, per floor, per room, and/or per zone), an energy rate (e.g., local or national energy rate), a labor rate (e.g., local labor rate), a control rebate, etc. The solution may include one or more of a bill of material (BOM) for the project, a cost estimate for the project, an estimate on different return on investment metrics for the project, energy savings of the project, etc. The solution may be broken down by project, by building, by floor, by room, and/or by zone. By utilizing high level variables, the energy savings and cost estimation tool allows a user who does not have complex equipment and/or expansive knowledge of all factors that go into creating a solution to create an accurate, customized solution for the potential customer.

Recursive database optimization may utilize override input data to adjust assumption input data to optimize a solution. The recursive database optimization may be utilized by a tool that generates a solution, such as an energy savings and cost estimation tool, for example. The energy savings and cost estimation tool may provide a solution based on high level variables. The energy savings and cost estimation tool may make assumptions (e.g., using assumption input data) based on the high level variables in order to arrive at the solution. A user may be provided with one or more of the underlying assumptions. A user may provide override input data to replace the underlying assumption data within one or more assumptions. The energy savings and cost estimation tool may then adjust the solution based on the override input data provided by the user to provide a more accurate and customized solution.

The energy savings and cost estimation tool may be configured for a single copy, multiple paste operation of information. Information, such as room information, for example, may be copied via a single copy operation. The copy operation may be, for example, a press and hold of an icon on a screen of an electronic device. After performing the single copy operation, the information may be duplicated one or more times via one or more paste operations without having to perform additional copy operations. The paste operation may be, for example, a single press of a paste icon on a screen of the electronic device, where, for example, the paste icon may be automatically generated and displayed on the screen after performing the copy operation. Therefore, information may be copied via one operation and duplicated a plurality of times via a plurality of paste operations without the need to recopy the information after each paste operation.

### BRIEF DESCRIPTION OF THE DRAWINGS

FIG. 1 is a diagram illustrating an example of a project site.

FIG. 2 is a diagram illustrating an example system for providing accurate information on BOM, cost, and return on investment calculations on retrofit projects.

FIGS. 3A-3H provide example user interfaces for providing building wide and floor-by-floor information for an energy savings and cost estimation tool that may be provided on an electronic device.

FIGS. 4A-4Q provide example user interfaces for providing room-by-room and zone-by-zone information for an energy savings and cost estimation tool that may be provided on an electronic device.

FIGS. 5A-5I provide example user interfaces for providing additional project information for an energy savings and cost estimation tool that may be provided on an electronic device.

FIGS. 6A-6H provide example user interfaces for providing a solution for an energy savings and cost estimation tool that may be provided on an electronic device.

FIG. 7 is a diagram illustrating example energy savings variables.

FIG. 8 is a diagram illustrating an example of how the energy savings and cost estimation tool may generate a solution for a project based on the received variables.

FIG. 9 is a diagram illustrating an example of a system that includes an energy savings and cost estimation tool and one or more databases.

FIG. 10 is a diagram illustrating an example of an energy calculation module.

FIG. 11 is a flow chart illustrating an example single copy, multiple paste operation.

FIGS. 12A-12C are diagrams illustrating an example of a single copy, multiple paste operation.

### DETAILED DESCRIPTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

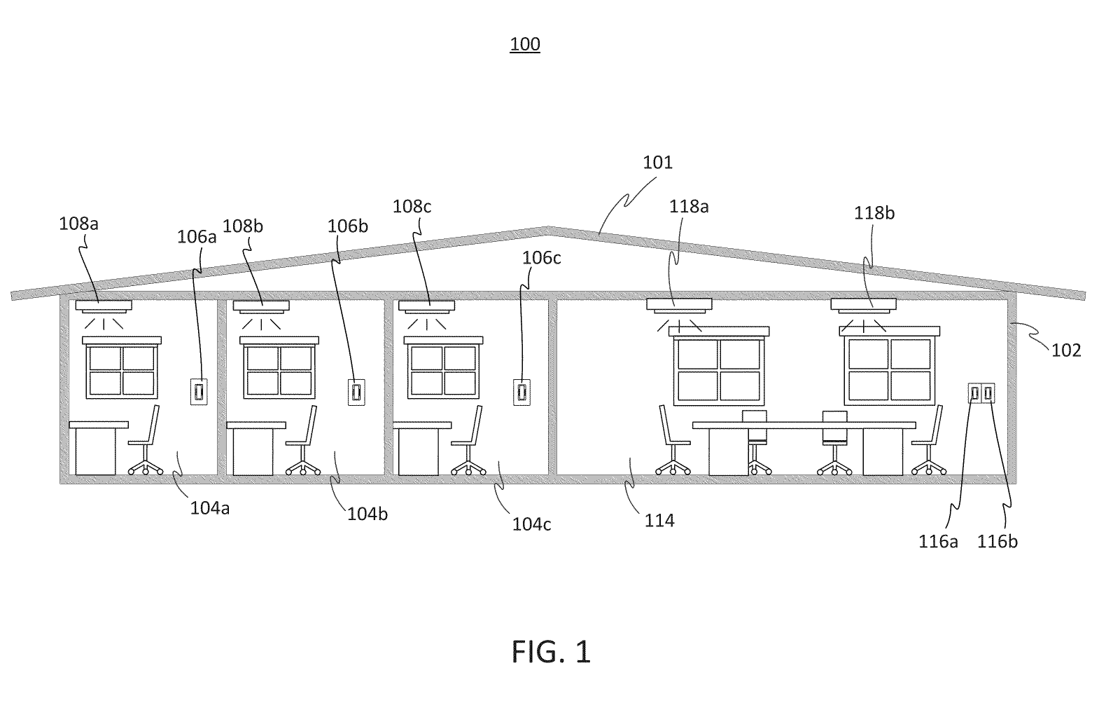

FIG. 1 is a diagram illustrating an example of a project site 100. The project site 100 may include a building 101. The building 101 may include one floor 102 that includes four rooms 104a, 104b, 104c, 104d. The four rooms may include three offices 104a, 104b, 104c and one conference room 104d. The office 104a may include a wall-mounted switch 106a that may control an overhead light 108a. The wall-mounted switch 106a and the overhead light 108a may be part of one zone. Similarly, the office 104b and office 104c may include a wall-mounted switch 106b, 106c that may control an overhead light 108b, 108c, respectively. The wall-mounted switch 106b, 106c and the overhead light 108b, 108c, respectively, may be part of one zone. The conference room 114 may include two zones. The first zone may include wall-mounted switch 116a that may control overhead light 118a. The second zone may include wall-mounted switch 116b that may control overhead light 118b.

As described in more detail herein, a user may utilize an energy savings and cost estimation tool to determine a solution for the project site 100, which may be a retrofit project. Although the description herein may refer generally to a retrofit project, wherein the project site may already have lighting and/or lighting controls installed that may be inefficient and in need of updating, the energy savings and cost estimation tool may also be utilized for new construction projects that may include one or more buildings that do not currently have any lighting or lighting controls installed.

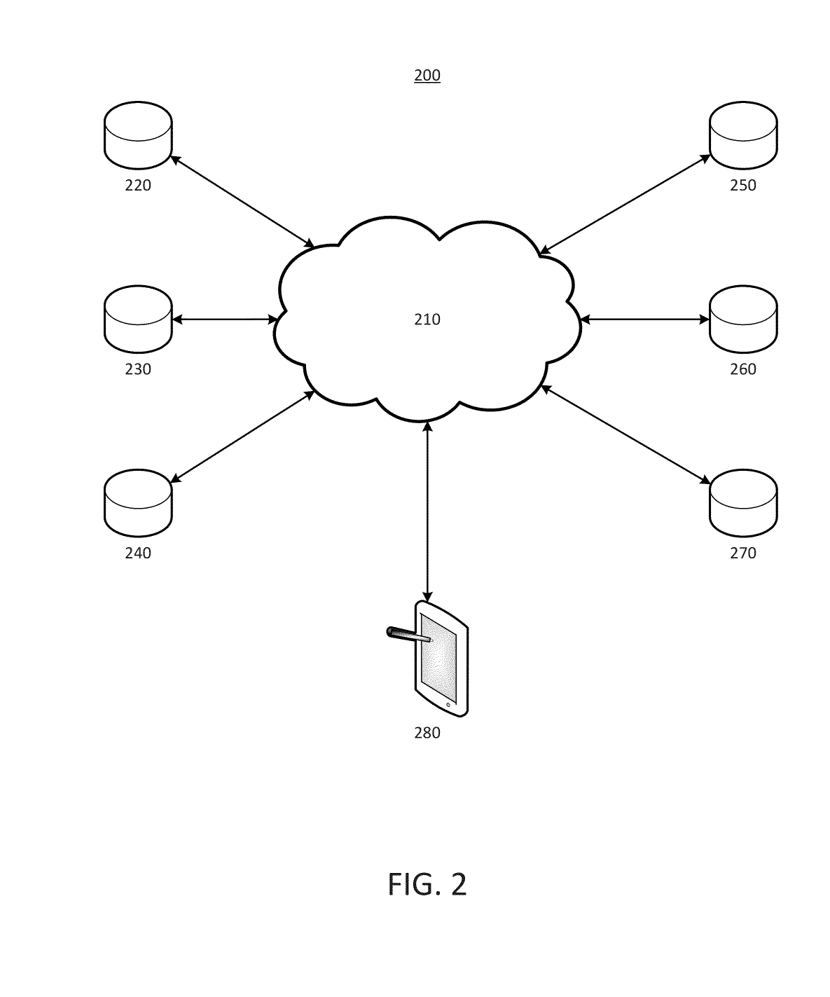

FIG. 2 is a functional diagram of an example of a system that may provide a solution for a project. For example, the system 200 may include an energy savings and cost estimation tool, for example, as described herein, that may provide a solution to a project (e.g., project site 100). The solution may include information relating to a BOM, total cost, energy savings, proposed fixtures, one or more strategies, a return on investment (ROI) calculation, an energy usage audit, an energy usage solution design, an energy analysis, etc. for a new or retrofit project (e.g., a lighting project). The system 200 may comprise a server 210, a cost database 220, a rebate and building codes database 230, a labor database 240, a product database 250, an energy database 260, an installed project database 270, and a user mobile device or PC 280.

The server 210 may receive data from one or more of the cost database 220, the rebate and building code database 230, the labor database 240, the product database 250, the energy database 260, and the installed project database 270. The server 210 may provide a solution to an electronic device 280. The server 210 may comprise one or more servers in operable communication with one another. The electronic device 280 may be, for example, a mobile device or PC 280. The server 200 may provide a solution for a project (e.g., a retrofit project for the project site 100) to the electronic device 280 based on information, such as project information, for example, gathered by a user and inputted into the electronic device 280 (e.g., into the energy savings and cost estimation tool).

The energy savings and cost estimation tool may reside on the electronic device 280. For example, the energy savings and cost estimation tool may be a mobile application that resides on the electronic device 280. The electronic device 280, via the energy savings and cost estimation tool, may provide a solution for the project based on the project information and data from the one or more databases of the system 200. For example, the solution may be a new or retrofit lighting solution for the project. The solution may include a cost, a BOM, an available rebate, labor cost, reseller information, state/local requirements, energy savings, proposed fixtures, one or more strategies, etc.

The cost database 220 may be a static or a dynamic database. For example, if the cost database 220 is a static database, then the cost database 220 may comprise a set wholesale price level (e.g., authorized stocking distributor), a set retail price level (e.g., non-authorized stocking distributor), and/or other set pricing. The set pricing may not change. If the cost database 220 is a dynamic database, then the cost database 220 may comprise prices from one or more distributors or resellers who may post their prices into the cost database 220. Therefore, the cost database 220 may comprise dynamically updating distributor or reseller price information. The cost database 220 may be configured to allow a user to select a distributor or reseller based on defined criteria, for example, price, convenience, location, etc. Therefore, the set pricing may change.

The rebate and building code database 230 may comprise rebate information, such as, lighting controls and/or lighting rebates, for example. The rebate and building code database 230 may be sorted by zip code, utility, state, etc. The rebate and building code database 230 may include local codes, regulations, requirements, etc. The rebate and building code database 230 may be dynamically updated. The rebate and building code database 230 may be populated by a third party.

The labor database 240 may be static or dynamic. If the labor database 240 is static, then the labor database 240 may be set by state/locality, for example, based on one or more labor studies. If the labor database 240 is dynamic, then the labor database 240 may be configured to allow a contractor to post labor rates, for example, by task, system, typical BOM, etc. The labor database 240 may comprise a plurality of trained contractors and their associated rates. The labor database may be updated dynamically by contractors, etc.

The product database 250 may comprise one or more products, for example, lighting products, such as, lighting fixtures, lighting controls, lighting sensors, lighting accessories, etc. The products may include existing products of a project site that a customer may wish to replace and new products that the customer may wish to install in a new and/or a retrofit project. For example, the new products may provide the best, least-expensive, most energy efficient, or other alternate solution to a customer.

The energy database 260 may comprise energy information, such as energy costs, and energy savings information, for example. The energy information may relate to products (e.g., lighting products) or costs (e.g., cost of a kWh). The energy information may be sortable by fixtures type, control type, location, space type, zip code, etc. The energy information may be based on industry studies. The energy information may be based on results determined from existing projects.

The installed project database 270 may comprise information relating to existing and/or preinstalled projects. The information may include the total cost of a product, the BOM, the sequence of operations (SOO), the energy used/saved, area information, geographical information, one or more space types of the project, the space size, the project type, the cost of labor to install the project, the operating expenses (e.g., before and after the retrofit), the components (e.g., the fixtures, controls, sensors, accessories, etc.), a lifetime of components, etc.

The electronic device 280 may receive input from a user relating to an existing project, for example, via an energy savings and cost estimation tool residing on the electronic device 280. For example, the project may be a new or retrofit lighting project and the information may include project information such as, but not limited to, the size of the project (e.g., in square feet), the existing fixture types, the existing wattage, the existing installed controls, the existing energy usage, etc. The electronic device 280 may take and receive pictures of a room/space, may tag a location (e.g., via GPS), for example, to allow for automatic recommendation of system based on state/local regulations. The electronic device 280 may take a picture of an installed system and instruct the server 210 to recognize the product (e.g., automatically) using the product database 250.

The electronic device 280 may include a control circuit (not shown) for controlling the functionality of the electronic device 280. The control circuit may include one or more general purpose processors, special purpose processors, conventional processors, digital signal processors (DSPs), microprocessors, integrated circuits, a programmable logic device (PLD), application specific integrated circuits (ASICs), or the like. The control circuit may perform signal coding, data processing, power control, input/output processing, or any other functionality that enables the electronic device 280 to perform as described herein. The control circuit may store information in and/or retrieve information from memory (not shown) of the electronic device 280.

The memory may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory.

The electronic device 280 may include a wireless communications circuit (not shown) for wirelessly transmitting and/or receiving information. The wireless communications circuit may include an RF transceiver or other circuit capable of performing wireless communications via an antenna (not shown) of the electronic device 280. Wireless communications circuit may be in communication with control circuit for transmitting and/or receiving information.

The control circuit may also be in communication with a display (not shown) of the electronic device 280 for providing information to the user. The display and the control circuit may be in two-way communication, as the display may include a touch screen module capable of receiving information from a user and providing such information to the control circuit. Each of the modules within the electronic device 280 may be powered by a power source (not shown). The power source may include an AC power supply or DC power supply, for example. The power source may generate a supply voltage V_{cc} for powering the modules within the electronic device 280.

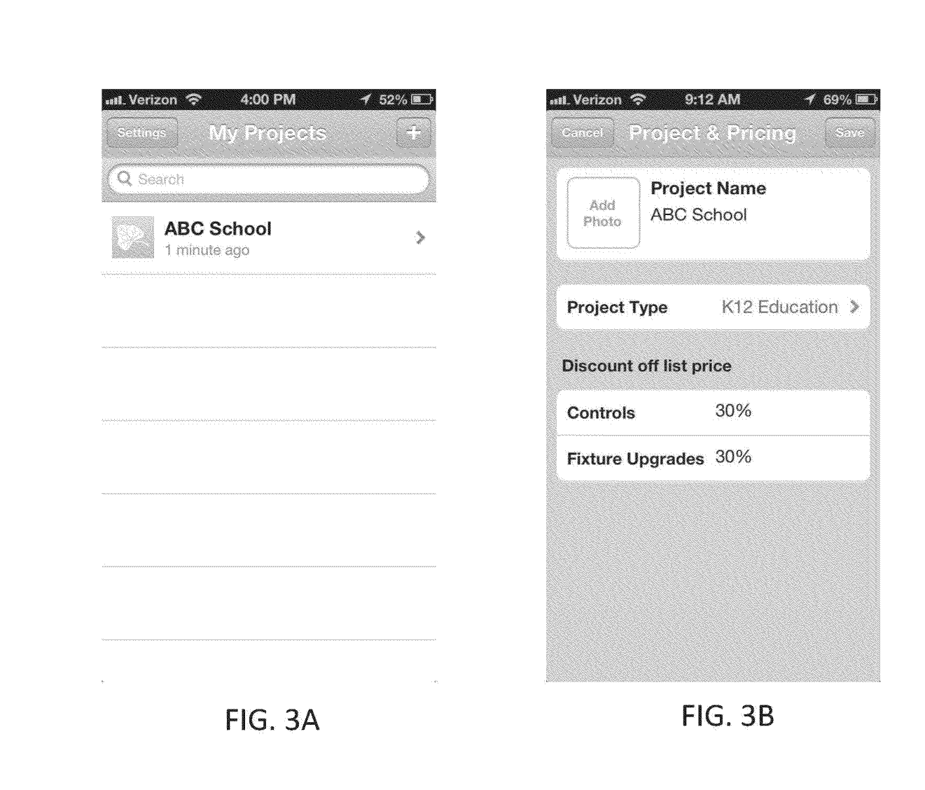

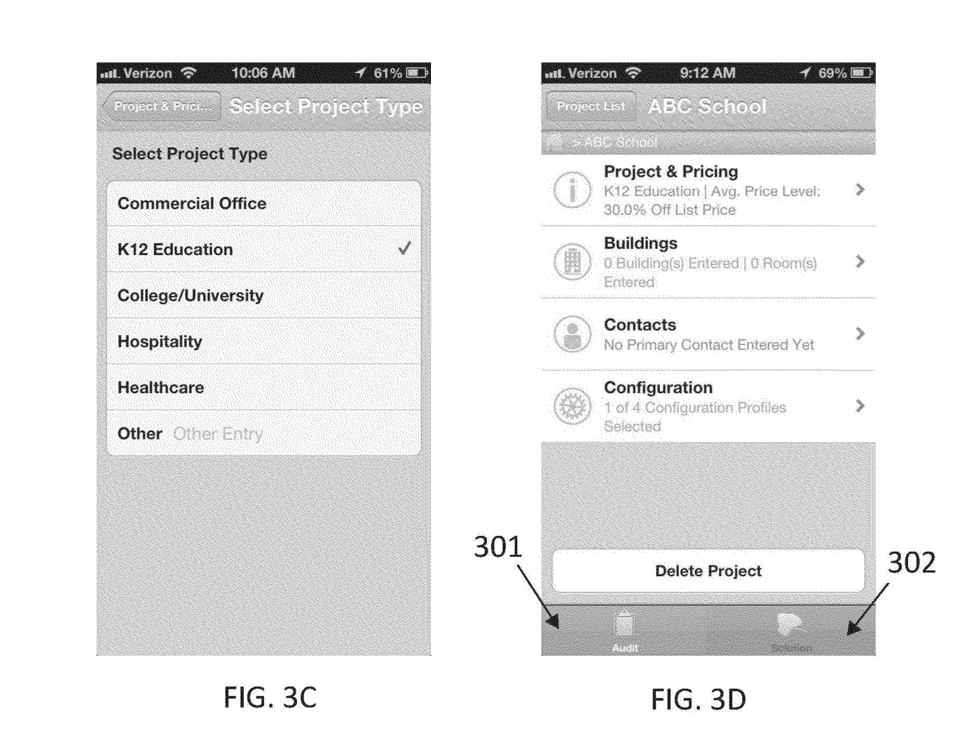

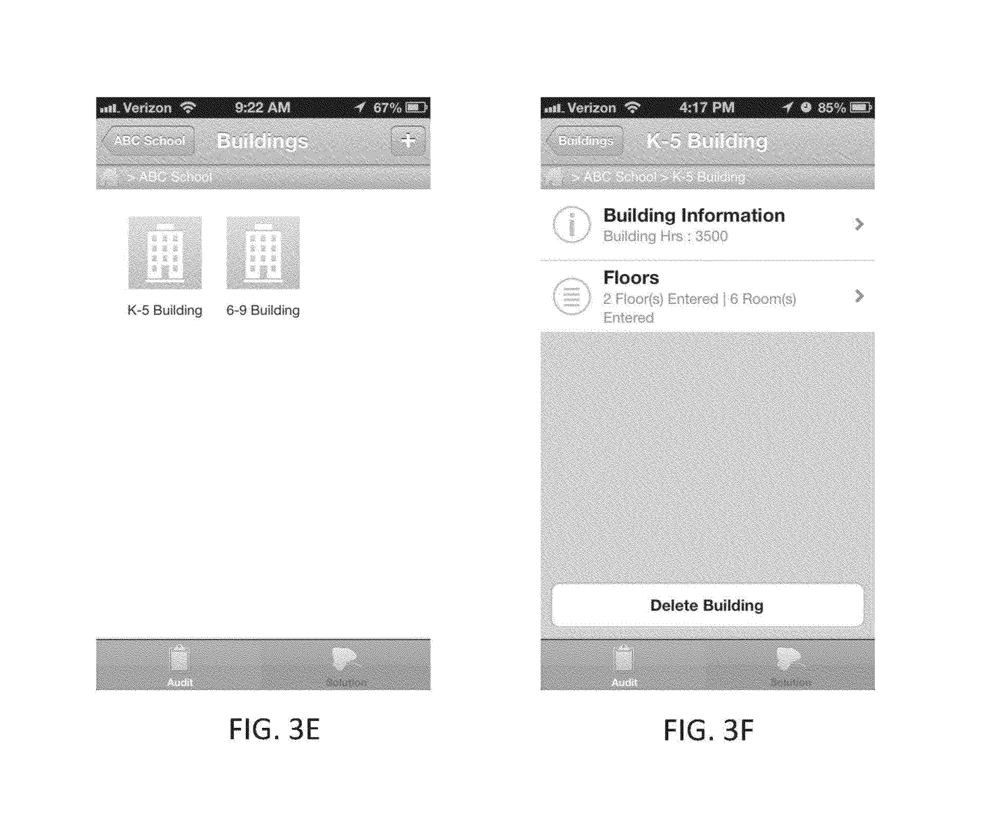

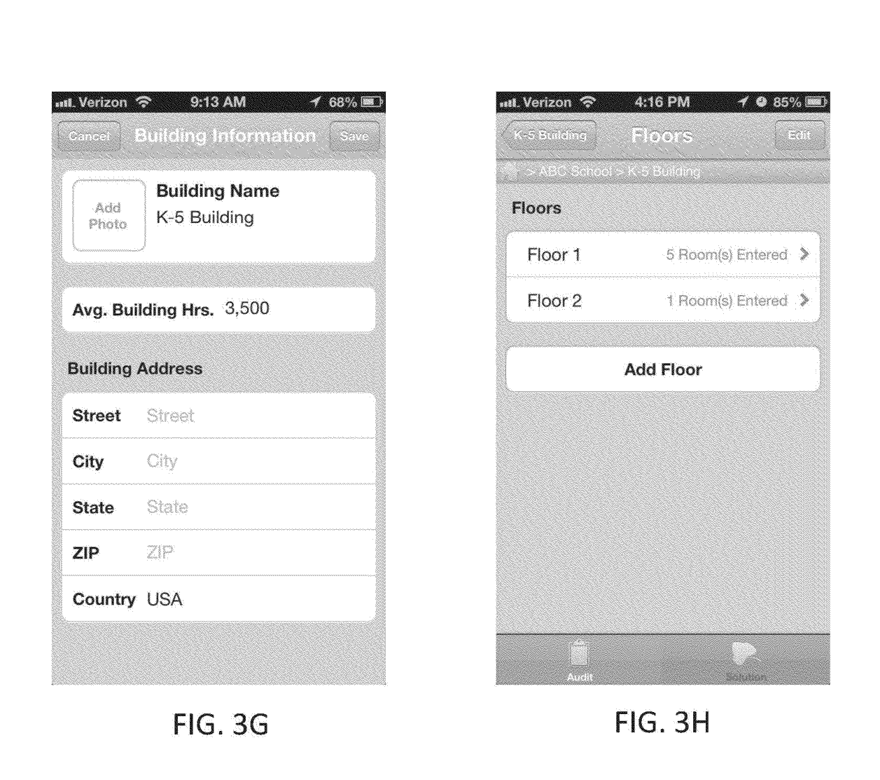

FIGS. 3A-3H, FIGS. 4A-4Q, 5A-5I, and 6A-6H illustrate example user interfaces of an energy savings and cost estimation tool that may be provided on an electronic device. An energy savings and cost estimation tool for an electronic device may be provided. The energy savings and cost estimation tool may be implemented on a mobile electronic device, such as, but not limited to a laptop computer, tablet, or a smart phone, for example. The energy savings and cost estimation tool may be a mobile application residing on the mobile device. For example, the energy savings and cost estimation tool may be a mobile application that resides on the electronic device 280 and utilizes the system 200.

A user of the energy savings and cost estimation tool may define information relating to a current project (e.g., the project site 100). A user may be a user of the energy savings and cost estimation tool. The project may be a new lighting project or a retrofit lighting project, for example. The user may define project information (e.g., audit information), such as, for example, building information, room information, zone information, etc. using the energy savings and cost estimation tool. A project (e.g., the project information) may include many different levels. For example, a lighting project may include multiple buildings, which may include multiple floors, which may include multiple rooms, which may include multiple lighting zones, which may include multiple fixture types, which may include multiple lamps, all of which may be defined by the user using the energy savings and cost estimation tool.

The user may define the project information while they are on the project site (e.g., at the physical location of the project). For example, the user may define the project information while they walk a project site using energy savings and cost estimation tool, which may reside on a mobile electronic device. The energy savings and cost estimation tool may receive the project information and determine one or more solutions for the customer. For example, the energy savings and cost estimation tool may determine the one or more solutions in real-time, while the user is still at the project site. This allows the user to provide a solution to the customer without having to return to an office to perform calculations.

The project information provided by the user may be high level variables/information relating to the project. For example, the project information may include high level variables, such as, the number of buildings in a project, the number of floors per building, the number and type of the rooms on each floor, the existing lighting information, etc. The project information may be considered high level since the user may not require any special equipment (e.g., light meter, existing energy or usage monitoring equipment, etc.) or any special knowledge about the project site (e.g., usage patterns, total project energy usage, etc.) to determine the project information utilized by the energy savings and cost estimation tool.

The project information may include one or more of a project type, a total number of buildings of the project, a total yearly operating hours of the project, a number of floors per building of the project, a number of rooms per floor of the project, a room type for a room of the project, a size of a room of the project, whether a room has windows, a number of zones per room of the project, an existing fixture, an existing lighting control, an existing sensor, and heating, ventilating, and air conditioning (HVAC) information. A collection of project information for a project may be referred to a as project profile.

After defining the project information (e.g., high level project variables), the user may generate a solution for the customer using the energy savings and cost estimation tool. For example, the solution may be a lighting solution (e.g., a lighting retrofit solution) that includes information relating to a strategy (e.g., a lighting control strategy), a bill of materials (BOM), costs, energy savings, a ROI metric, rate of return, an energy usage audit (e.g., existing energy usage of the project site, energy usage of a proposed strategy of the solution, etc.), etc. The solution may include a combination of two or more lighting control strategies. A strategy may be a combination of components (e.g., dimming ballasts, dimming controls, occupancy sensors, vacancy sensors, daylight harvesting, etc.) that when utilized together may provide a benefit, such as energy savings, for example, for a project. The solution may be displayed or delivered to a customer, for example, while the user is still at the project site. Further, after providing a solution to the user, additional information may be entered into the energy savings and cost estimation tool and updated solutions may be provided. Therefore, the energy savings and cost estimation tool may provide solutions to the customer that may be updated dynamically as additional/updated information is provided. Using the energy savings and cost estimation tool, the user may discuss the project and/or proposal with a potential customer, ask questions about the project, walk around the project site, define project information, and generate a solution for the customer, all without having to utilize special equipment, have specific knowledge of detailed variables or detailed project information, or perform complex calculations.

The energy savings and cost estimation tool may provide the user with an assessment of the project, for example, as the project information is defined. For example, the energy savings and cost estimation tool may generate an assessment of the project before all of the project information is defined. The assessment of the project may include, for example, an estimate of existing energy usage of the project, proposed energy usage of a solution, energy savings, etc. Therefore, the energy savings and cost estimation tool may provide the user with a real-time, dynamically updating assessment of the project as the user is walking around the project site and defining project information. The assessment of the project may be part of a solution.

Referring to FIGS. 3A-3C, a user may create a project using the energy saving and cost estimation tool. A project may be, for example, a new project, a retrofit project, etc. As described herein with reference to FIGS. 3A-3H, FIGS. 4A-4Q, 5A-5I, and 6A-6H, the project may be a retrofit lighting project, for example. The user may define a project name, a project type, and one or more discounts. Further, the user may take and store a photo of the project, for example, using a camera residing on the electronic device. The project type may be selected from a list of predefined project types, for example, as shown in FIG. 3C. For example, the project type may refer to the building type of the project (e.g., the building being retrofitted), for example, a commercial office, K12 education, college/university, hospitality, healthcare, a sporting venue, etc. Each project type may comprise one or more underlying assumptions relating to information about the project. For example, the assumptions may be related to the operating hours of the project (e.g., yearly operating hours), the room types, recommended light level (e.g., per room), recommended fixture types, recommended strategies, etc. As described herein, the energy savings and cost estimation tool may utilize the assumptions along with project information provided by the user to generate one or more solutions for the project.

After creating a project using the energy savings and cost estimation tool, the user may enter building information. The energy savings and cost estimation tool may include an audit mode and a solution mode. In the audit mode, the user may define information relating to the project into the energy savings and cost estimation tool. In the solution mode, the energy savings and cost estimation tool may generate a solution based on the entered project data. For example, the energy savings and cost estimation tool may include an audit icon and a solution icon (e.g., audit icon 301 and solution icon 302 as shown in FIG. 3D) that are operable to switch the energy savings and cost estimation tool between the audit mode and the solution mode, respectively.

After selecting a building type, the energy savings and cost estimation tool may predefine floors, rooms, zones, fixtures, etc. for the building. The user may then override the predefined project information, for example, as described herein. After selecting a building type, the energy savings and cost estimation tool may allow the user to define floors, rooms, zones, fixtures, etc. for the building without any predefined project information already included. The energy savings and cost estimation tool may generate a project profile. The project profile may be a compilation of project information for a current project, such as the project information defined by the user, for example.

Referring to FIGS. 3D-3H, a project (e.g., a school) may comprise one or more buildings. Each building may be broken down by floor, and further by room. Using the energy savings and cost estimation tool, the user may define each building within the project (e.g., as shown in FIG. 3E). Within each building, the user may define building information and floor information (e.g., as shown in FIG. 3F). The building information may include a building name, a building address, and an average of building hours, for example, on an average yearly basis (e.g., as shown in FIG. 3G). The floor information may include the total number of floors in the building (e.g., as shown in FIG. 3H).

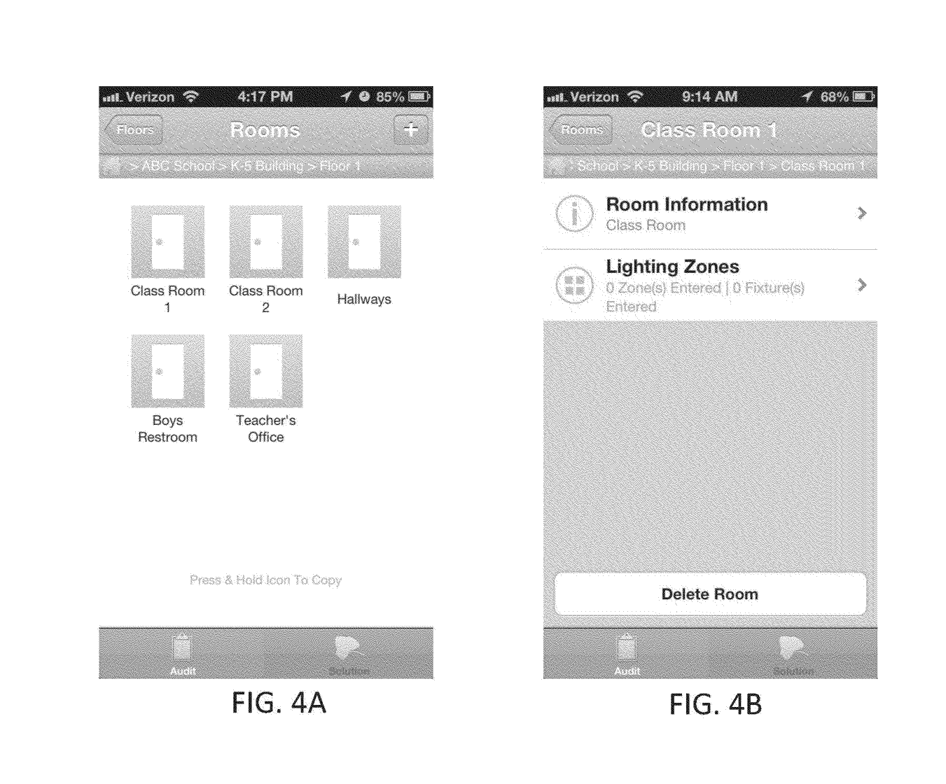

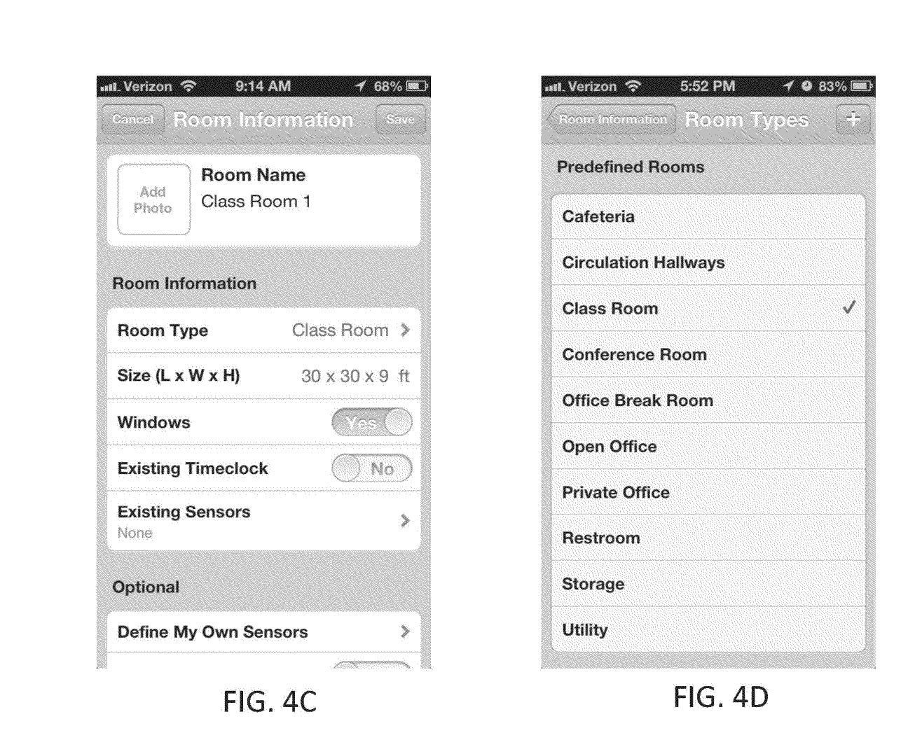

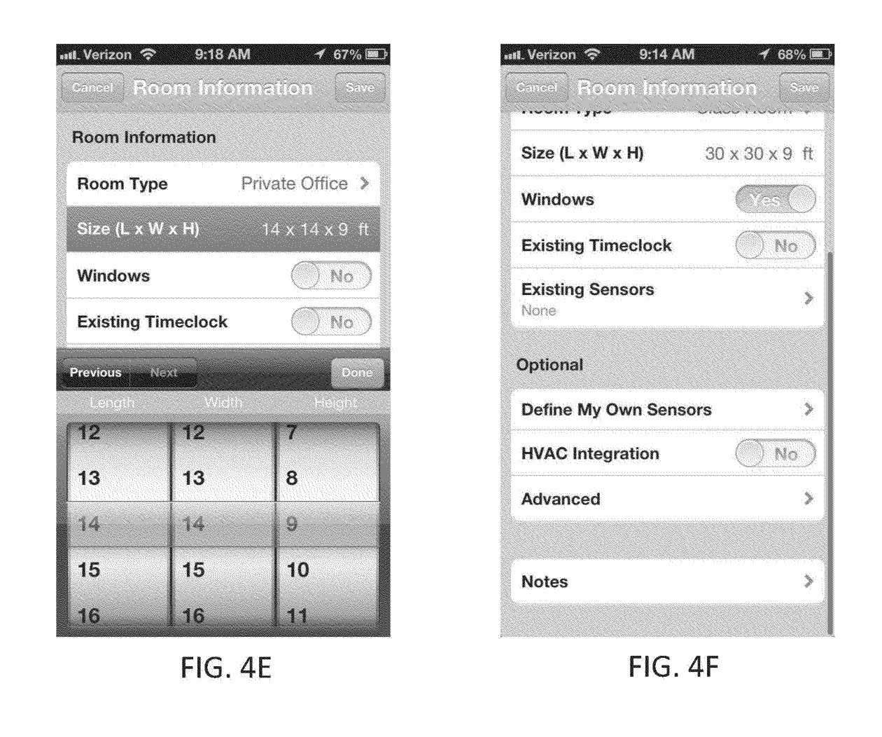

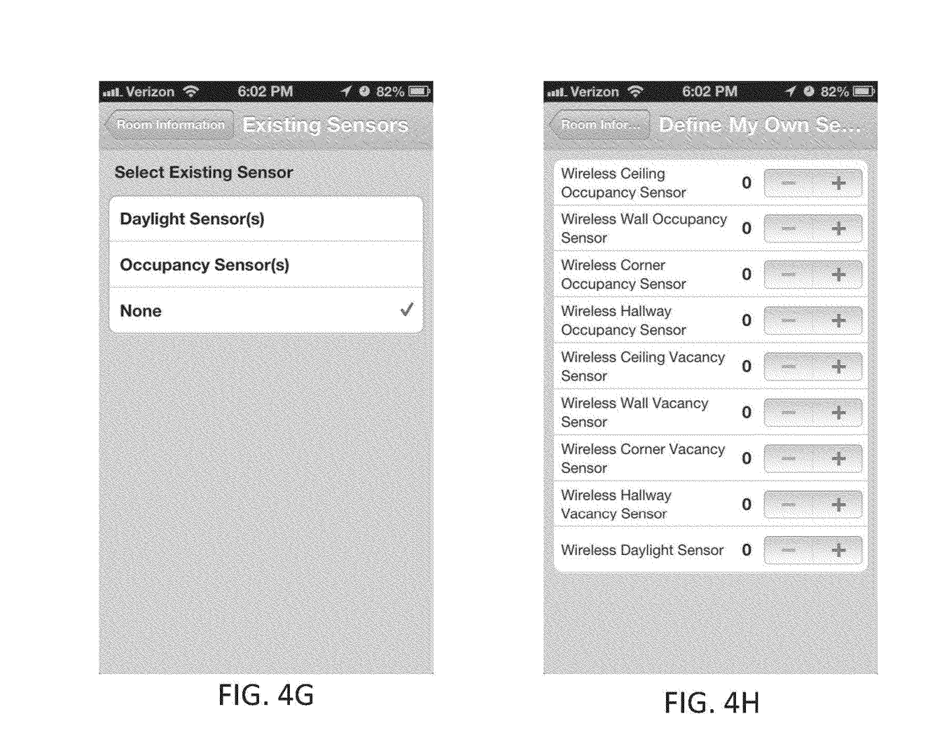

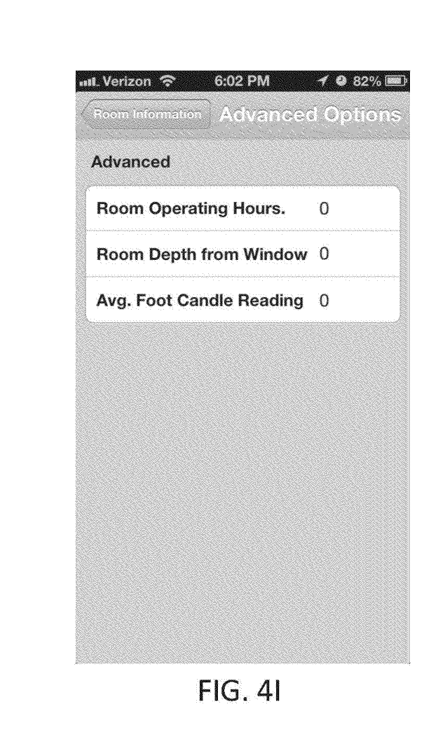

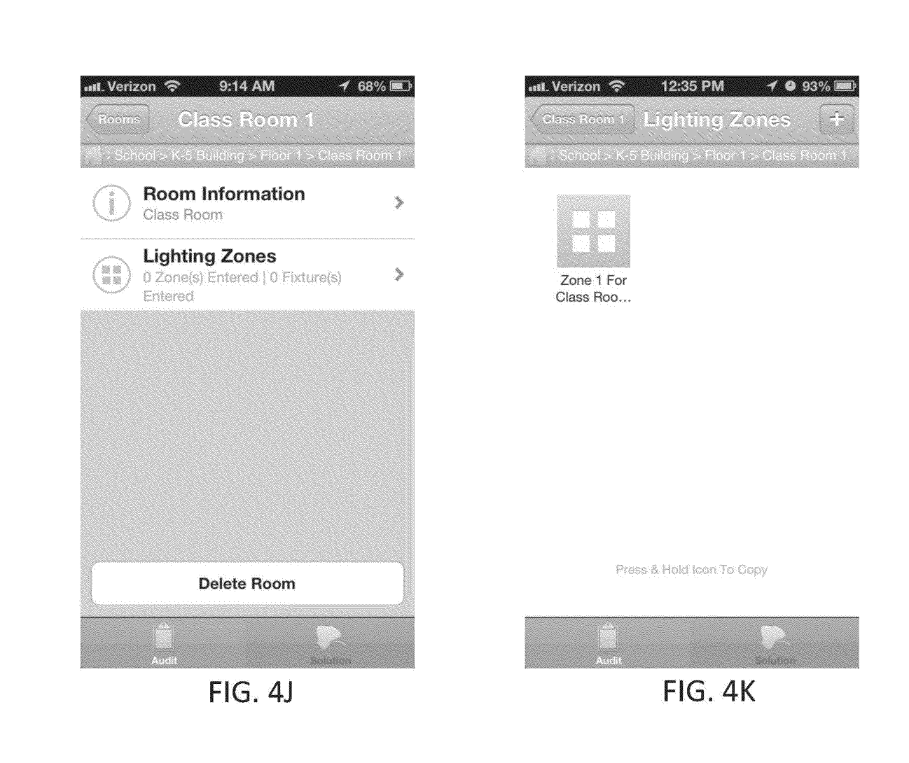

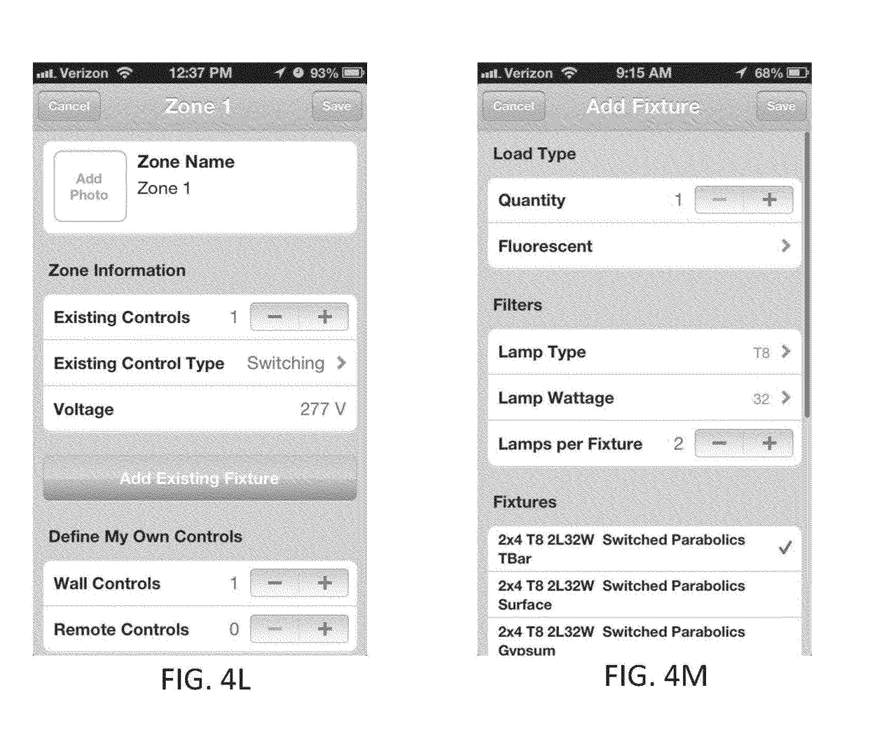

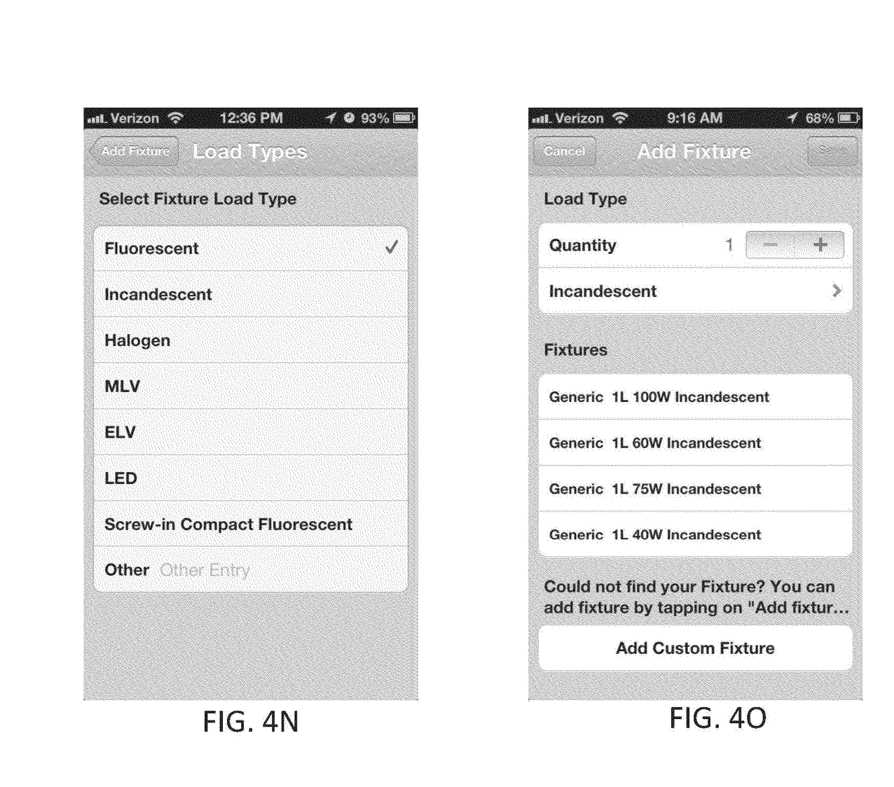

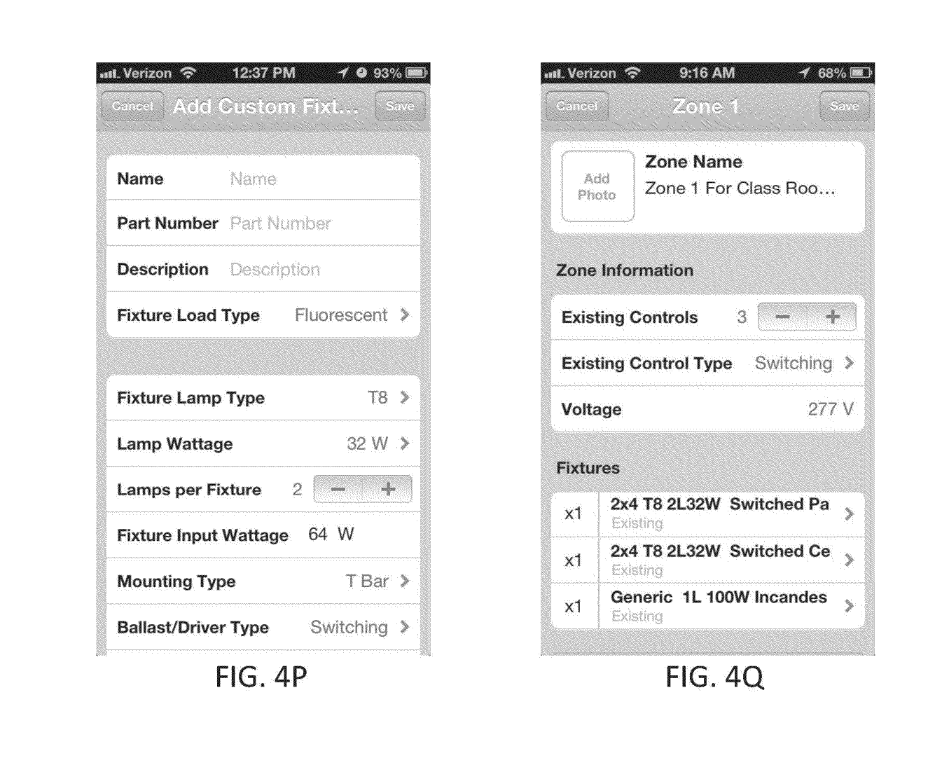

Referring to FIGS. 4A-4I, after defining the floor information using the energy savings and cost estimation tool, the user may define room information. A user may add a room to a floor of a building using the energy savings and cost estimation tool. Each floor may include a plurality of rooms, for example, where the rooms may be of different room types (e.g., as shown in FIG. 4A). After adding a room, the user may define room information and zone information (e.g., as shown in FIG. 4B). The room information may include a room name, a room type, a size for the room, whether or not the room has windows, whether or not the room has an existing timeclock, existing sensors of the room, etc. (e.g., as shown in FIG. 4C). The user may select a room type from a list of predefined room types, such as cafeteria, circulation hallways, class room, conference room, office break room, open office, private office, restroom, storage, and utility, for example. The predefined room types may be specific for the building type. Each predefined room type may include information relating to the room that is adjustable by the user, such as room size, and information that is not visible to the user, such as information relating to emergency power level of the room and information relating to how different solutions may affect the lighting efficiency and energy savings of the room, for example.

After selecting a room type, an average size of that room type will be selected, for example, selected automatically by the energy savings and cost estimation tool. The user may override the preset room size to more accurately conform to the specifics of the room they are evaluating (e.g., as shown in FIG. 4E). The user may indicate whether or not the room has windows or an existing timeclock (e.g., as shown in FIG. 4F). The user may indicate if the room currently has any existing sensors installed. The existing sensors may include, for example, daylight sensors, occupancy sensors, vacancy sensors, etc. (e.g., as shown in FIG. 4G).

The room information may also include additional inputs (e.g., optional inputs), such as additional sensor information, whether or not the room has HVAC integration, and advanced room information, for example (e.g., as shown in FIG. 4F). The additional sensor information may include information relating to whether or not the room has any additional sensors, and the number and type of those additional sensors (e.g., as shown in FIG. 4H). The additional sensor information may include information relating to wired or wireless sensors, such as, wired/wireless ceiling occupancy sensor information, wired/wireless wall occupancy sensor information, wired/wireless corner occupancy sensor information, wired/wireless hallway occupancy sensor information, wired/wireless ceiling vacancy sensor information, wired/wireless wall vacancy sensor information, wired/wireless corner vacancy sensor information, wired/wireless hallway vacancy sensor information, wired/wireless daylight sensor information, etc., for example.

The advanced room information may include the average operating hours of the room (e.g., the lighting operating hours of the room, for example, on a yearly basis), the room depth from a window, the average footcandle reading in the room with the existing lighting equipment, room energy usage (kW), etc. (e.g., as shown in FIG. 4I). The advanced room information may be utilized by the energy savings and cost estimation tool as override input information. For example, if the user does not enter any advanced room information, then the energy savings and cost estimation tool may make assumptions based on the other provided room information (e.g., room type, room size, building operating hours, etc.) to determine the advanced room information. However, if the user does enter any advanced room information, then the energy savings and cost estimation tool may override one or more of the assumptions using the user provided advanced room information. For example, the energy savings and cost estimation tool may override assumptions relating directly to the advanced room information that is provided (e.g., change the average foot candle reading from an assumed value to an entered value, change the room depth from the window to an entered value, etc.) and/or the energy savings and cost estimation tool may alter another underlying assumption unrelated to the advanced room information provided.

Referring to FIGS. 4J-4Q, after room information is entered into the energy savings and cost estimation tool, the user may define zone information for each room using the energy savings and cost estimation tool (e.g., as shown in FIG. 4J). For example, the user may define one or more zones per room (e.g., as shown in FIG. 4K). A zone may be a lighting zone, for example. Each zone may include zone information, such as a zone name, a number of existing controls, the existing control type, the zone voltage, the existing fixtures of the zone, and the number and type of controls for the zone, for example (e.g., as shown in FIG. 4L). The existing control type may include, but is not limited to, switching, dimming, occupancy sensor, vacancy sensor, daylight harvesting, personal dimming, etc. The existing voltage may include standard voltages (e.g., 277 V, 120 V, etc.) or may be customizable by the user.

The user may add one or more fixtures (e.g., existing fixtures) to a zone. The existing fixtures may be those fixtures that are currently installed in the building of the project site, for example, broken down on a zone-by-zone basis. By defining the existing fixtures of the project site, the energy savings and cost estimation tool may determine the current operating conditions (e.g., energy usage and lighting efficiency) of the project site, which may allow the energy savings and cost estimation tool to determine a solution for the project site. The user may define each fixture using fixture information that may be entered into the energy savings and cost estimation tool. The fixture information may include, for example, load type, quantity, lamp type, lamp wattage, lamps per fixture, etc. (e.g., as shown in FIG. 4M). The user may select from a list of different load types, such as, for example, fluorescent, incandescent, halogen, MLV, ELV, LED, screw-in compact fluorescent, etc. (e.g., as shown in FIG. 4N). After the user selects a load type, then the user may select one of a plurality of predefined fixture types of that specific load type (e.g., as shown in FIG. 4M and FIG. 4O). If the existing fixture current does not match a predefined fixture type, then the user may enter in custom fixture information to define the existing fixture (e.g., as shown in FIG. 4P). The user may define one or more fixtures for each zone and for each room of a building of a project (e.g., as shown in FIG. 4Q).

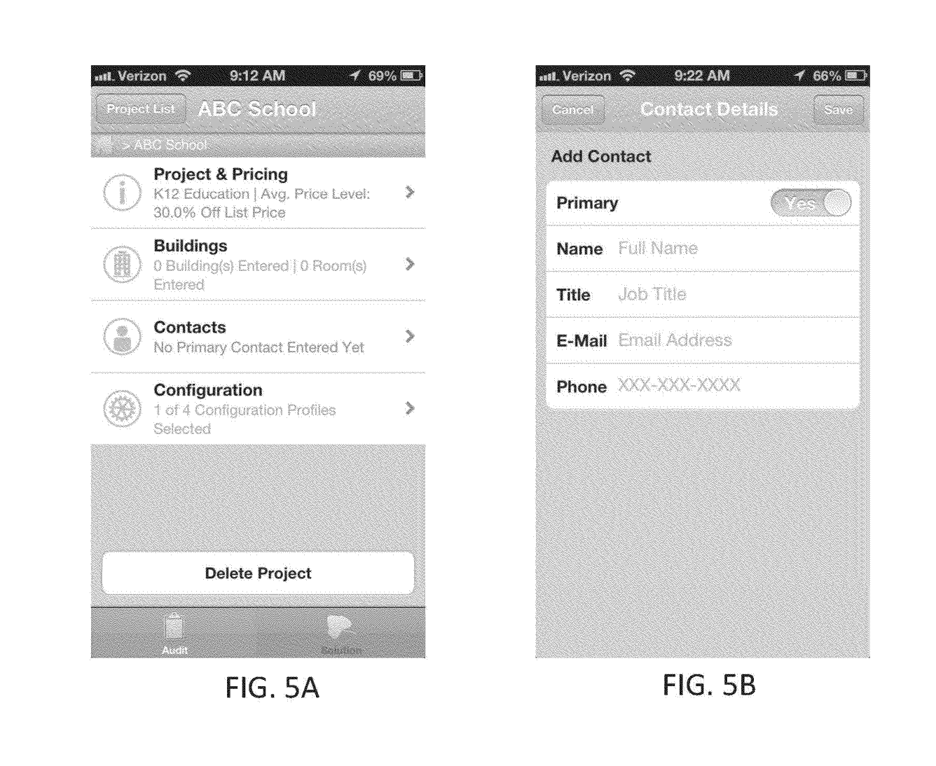

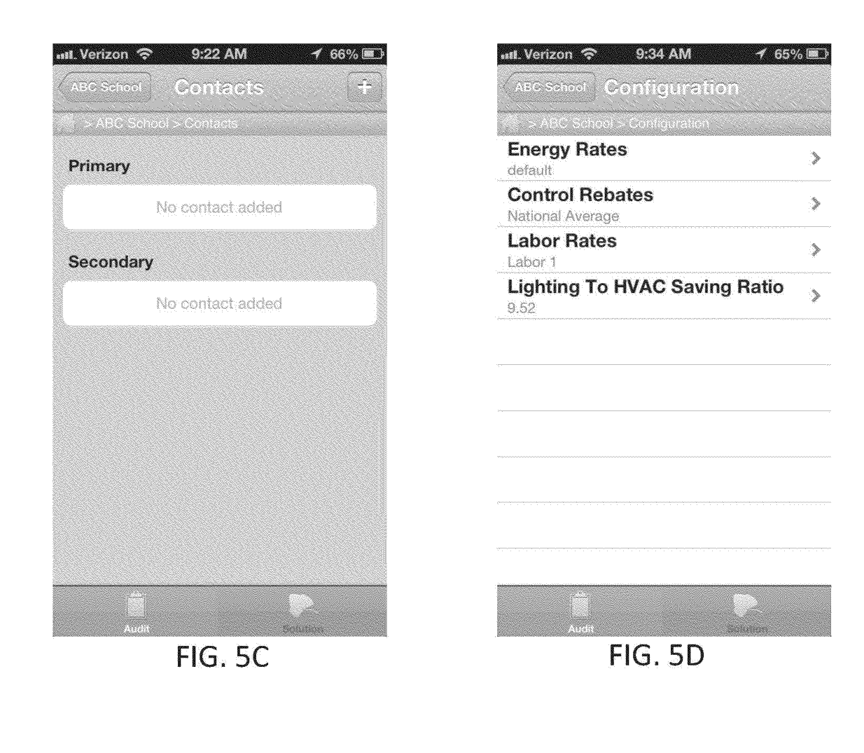

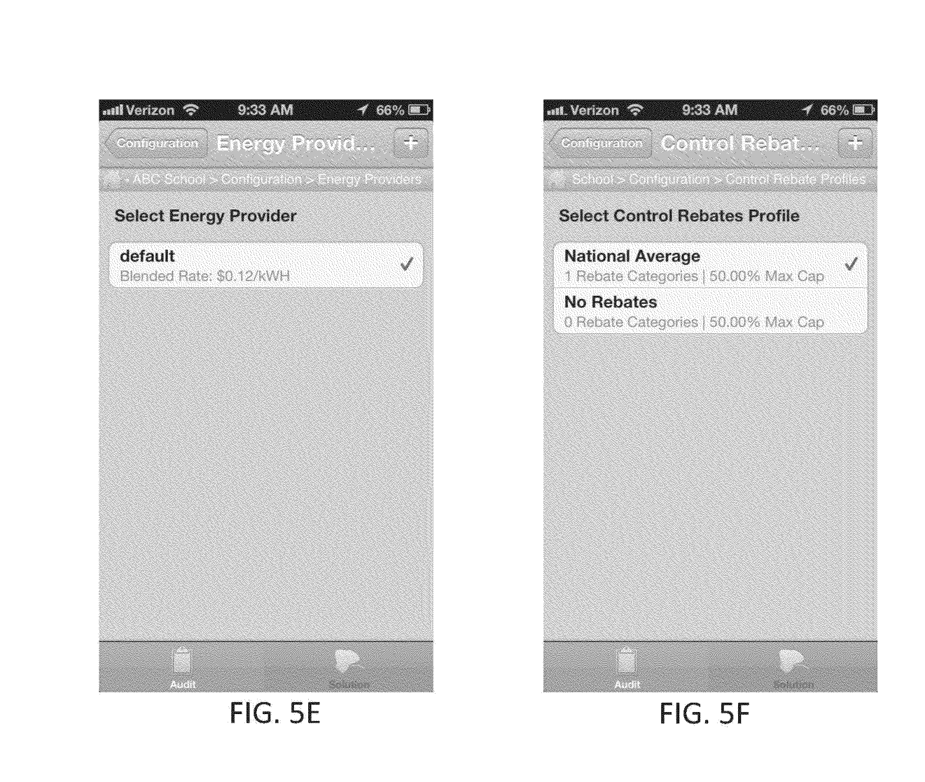

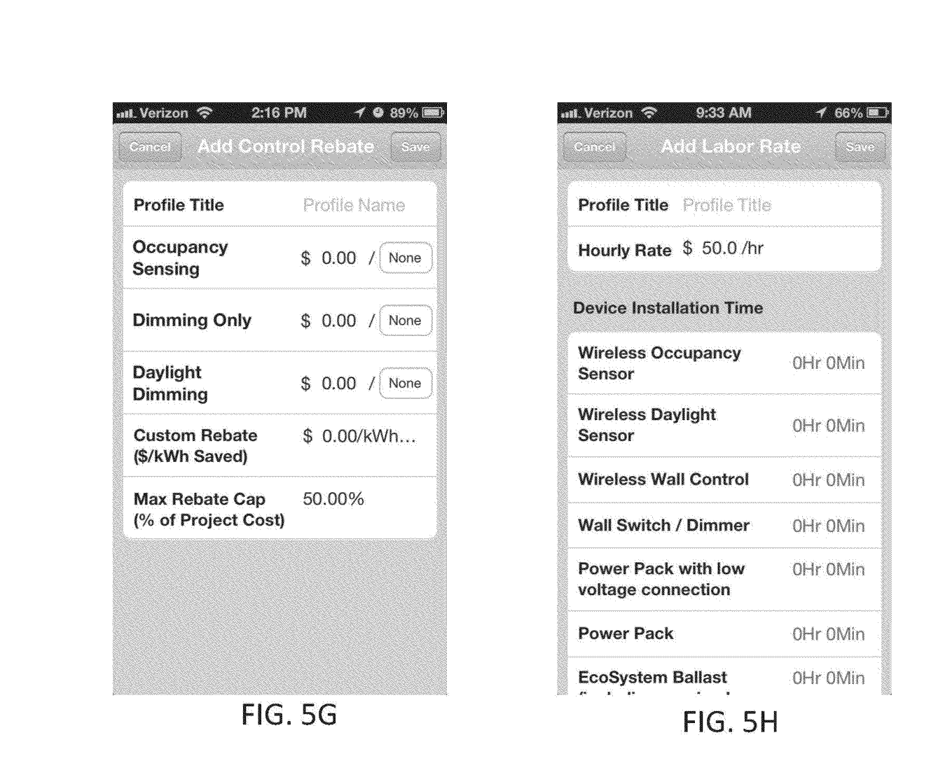

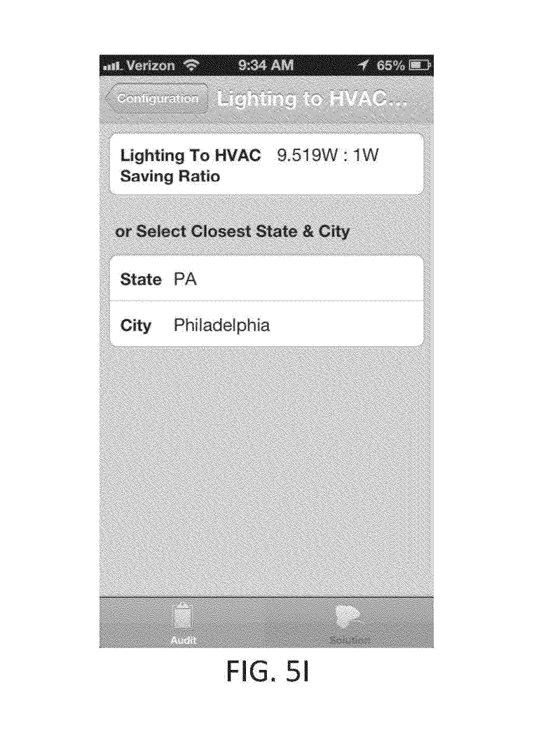

Referring to FIGS. 5A-5I, additional project information may be defined for each project using the energy savings and cost estimation tool. The additional project information may include contact information and configuration information (e.g., as shown in FIG. 5A). The user may provide contact information, such as name, title, email, and phone number, for example, for one or more contacts/customers for the project (e.g., as shown in FIG. 5B and 5C). For example, the email address may be utilized to automatically send a solution to the contact of the project.

The configuration information may include information relating to energy rates, energy rebates, control rebates, labor rates, and lighting to HVAC saving ratio (e.g., as shown in FIG. 5D). The configuration information may be set to a default value, for example, based on other project information received by the energy savings and cost estimation tool (e.g., project location). The configuration information may be utilized by the energy savings and cost estimation tool as override input information. The user may adjust the configuration information using the energy savings and cost estimation tool if they feel they have more accurate information. By adjusting the configuration information, the energy savings and cost estimation tool may adjust the underlying assumptions utilized associated with the configuration information (e.g., the configuration information itself and/or other related assumptions made by the energy savings and cost estimation tool).

Using the energy savings and cost estimation tool, the user may keep the energy rates at a default value or adjust the energy rate according to their own knowledge (e.g., as shown in FIG. 5E). The user may select a national average as the control rebate, apply no rebate, or define a control rebate specific for this customer (e.g., as shown in FIGS. 5F). The user may define control rebate information such as, for example, rebates for occupancy sensing, dimming, daylight harvesting, a custom rebate, a maximum rebate cap, etc. (e.g., as shown in FIG. 5G). Using the energy savings and cost estimation tool, the user may define a labor rate for the installation of the solution. For example, the user may define the labor rate on the basis of the types of the devices that may be proposed in the solution (e.g., as shown in FIG. 5H). The user may also adjust the lighting to HVAC saving ratio (e.g., as shown in FIG. 5I). This may be defined back on the location of the project or specified by the user.

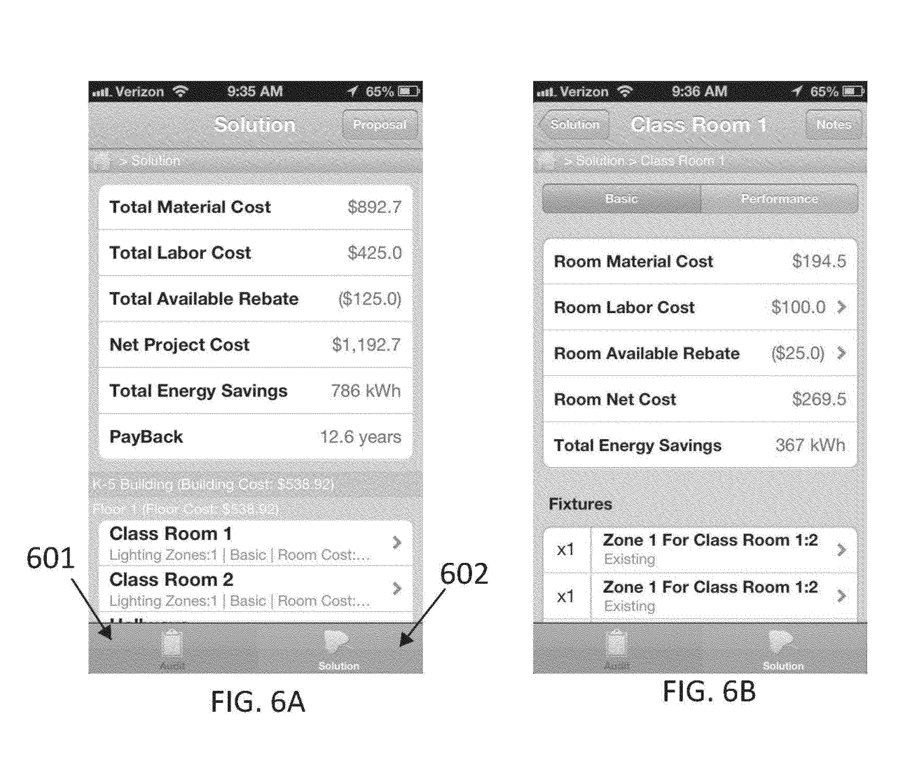

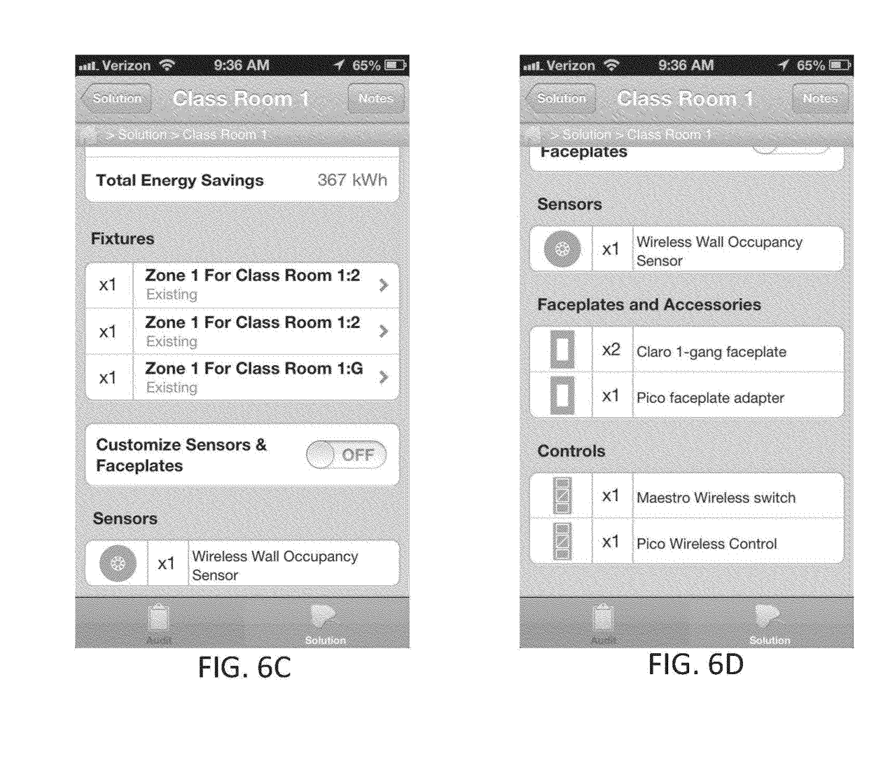

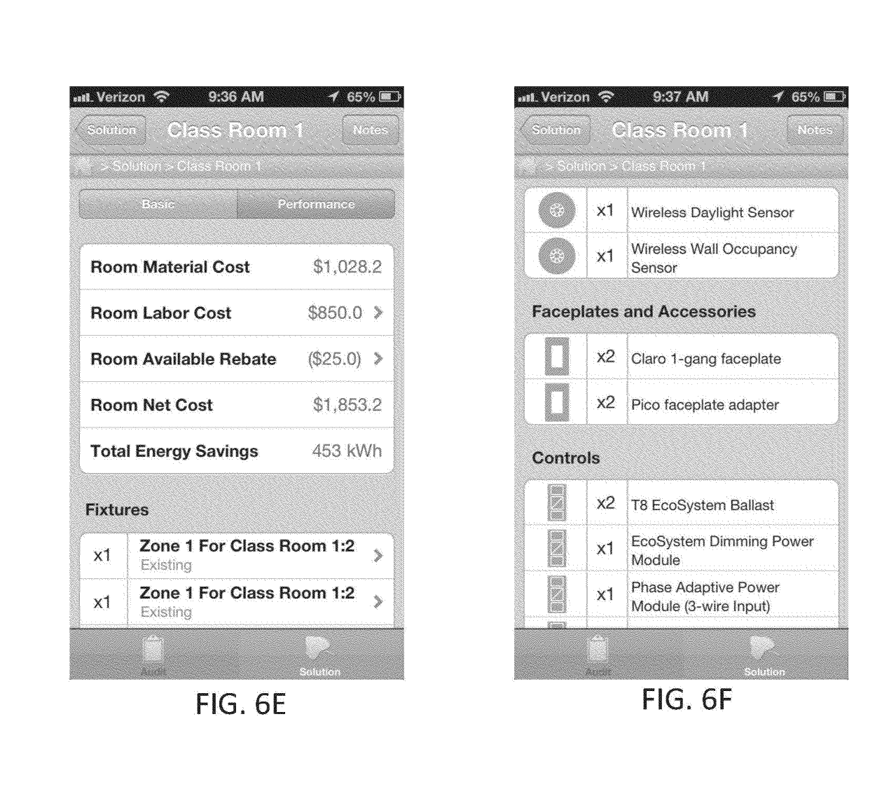

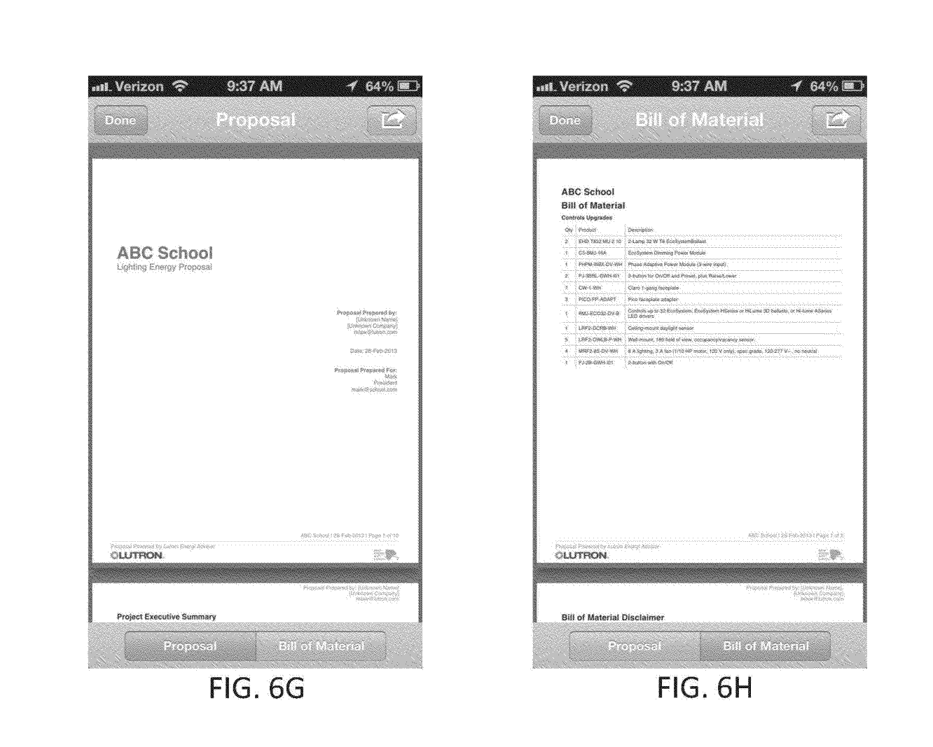

Referring to FIGS. 6A-6H, the energy savings and cost estimation tool may generate a solution for the project, for example, in real-time and while the user is still at the project site. As described above, the energy savings and cost estimation tool may be configured to switch between an audit mode and a solution mode, for example, via the actuation of an audit icon and a solution icon of the energy savings and cost estimation tool (e.g., audit icon 601 and solution icon 602 as shown in FIG. 6A). Upon actuating the solution icon, the energy savings and cost estimation tool may generate a solution for the project based on the project information entered in the audit mode. If at any point after generating a solution the user wants to switch back to the audit interface and update project information, they may do so by actuating the audit icon while viewing a solution. Thereafter, if the user re-enters the solution interface, then the energy savings and cost estimation tool may dynamically update the solution for the project using the updated project information.

The energy savings and cost estimation tool may generate the solution using the defined project information (e.g., high level project variables) and one or more assumptions. The solution may include information relating to a proposed solution for the project (e.g., a proposed lighting retrofit solution). The solution information for a proposed lighting retrofit solution may include, but is not limited to, the total material cost, the total labor cost, the total available rebate, the net project cost, one or more strategies, a ROI metric, an energy usage audit (e.g., existing energy usage of the project site, energy usage of a proposed strategy of the solution, etc.), the total energy savings, the payback period, etc. (e.g., as shown in FIG. 6A). The total material cost may be the total estimated cost of the material needed to implement the solution for the project. The total labor cost may be the total estimated cost of the labor needed to implement the solution for the project. The total available rebate may be the total estimated rebates that may be available if the solution for the project were to be implemented. The net project cost may be the net cost to implement the solution for the project. The total energy savings may be based on the different between an estimation of the existing energy used with the existing lighting components (e.g., fixtures, controls, etc.) and an estimation of the energy used with the proposed lighting components of the solution. The payback may an estimate of the time period in which the customer can expect to receive savings in energy costs that meet or exceed the cost to implement the solution.

The solution provided by the energy savings and cost estimation tool may be broken down by building, floor, room, and/or zone. For example, referring to FIG. 6B, the solution may be broken down on the room level. On the room level, the energy savings and cost estimation tool may provide the material cost, labor cost, rebate, net cost, energy savings, fixtures, sensors, accessories, controls, etc., of the solution for each room of the project (e.g., as shown in FIGS. 6B-6D). This allows the customer to see exactly what the solution proposes where, and how that affects the information relating to the solution.

The energy savings and cost estimation tool may provide more than one strategy within a solution. For example, the energy savings and cost estimation tool may provide a basic lighting strategy and an advanced lighting strategy for a lighting solution. Each strategy may be characterized by a unique set of components, such as sensors, controls, fixtures, accessories, etc., for example. The energy savings and cost estimation tool may determine the different strategies based on data analysis relating to the effectiveness of different combinations of the components (e.g., sensors, controls, fixtures, accessories, etc.). For example, the energy savings and cost estimation tool may compare a plurality of different combinations of components to determine those that provide the most cost effective benefit, the most energy efficient benefit, the quickest payback, a combination of cost and energy efficiency, etc. The energy savings and cost estimation tool may allow for a different strategy to be defined on the building level, floor level, and/or room level. For example, FIGS. 6B-6D may provide a basic lighting strategy that includes occupancy sensors, and FIGS. 6E-6F may provide an advanced lighting strategy that includes daylight harvesting and personal dimming in the rooms that have windows and personal dimming in rooms that do not have windows.

A strategy of a solution (e.g., the combination of fixtures, sensors, accessories, and/or controls) may be determined by the energy savings and cost estimation tool based on one or more factors, for example, a desired project cost, a desired energy savings, a desired payback, etc. The factors may be defined by the user or determined by the energy savings and cost estimation tool. For example, the user may define a desired total cost for the project, and the energy savings and cost estimation tool may determine the solution that provides the greatest energy savings or shortest payback based on the desired project costs. Similarly, the user may define the desired energy savings, and the energy savings and cost estimation tool may determine the solution that provides the lowest total project cost or shortest payback based on the desired energy savings. A similar approach may be performed with respect to a desired payback period. The energy savings and cost estimation tool may determine a solution by comparing a plurality of different potential strategies, and providing one or more strategies that are determined to be the most efficient. As described herein, the energy savings and cost estimation tool may utilize one or more databases to determine the solution.

As described above, a strategy of a solution may be characterized by one or more components. For example, a lighting strategy may include one or more fixtures, sensors, controls, and/or accessories. The components of a strategy may be adjusted by the user. For example, the user may change a component based on a customer's preference, a unique requirement of a project/building/room, etc. A component of a strategy may be set as the existing component (e.g., existing fixture of the project) or may be set as a recommended component (e.g., a recommended fixture according to the strategy). The user may change a set component (e.g., an existing fixture) to a desired component (e.g., an alternative fixture), for example, from a list of predefined components or via user entry. The predefined components may be determined by the energy savings and cost estimation tool according to the strategy, the existing components of the project, the room type, the building type, etc. If the user adjusts a component of a particular strategy, the energy savings and cost estimation tool may adjust the solution accordingly. For example, the energy savings and cost estimation tool may adjust information relating to the project cost, the energy savings, the expected payback, etc.

After determining a solution for the project, the energy savings and cost estimation tool may generate a proposal and/or BOM relating to a strategy of the solution (e.g., as shown in FIGS. 6G-6H). The energy savings and cost estimation tool may send the proposal and/or the BOM to the customer, for example, in real-time and while the user is at the project site.

As described herein, the energy savings and cost estimation tool may generate a solution for a project that includes energy savings information. The energy savings and cost estimation tool may include an energy calculation module that determines the energy savings metrics of the solution, for example, using the defined project information of the current project and one or more assumptions. The energy calculation module may reside (e.g., partially reside) outside of the energy savings and cost estimation tool, such as in a server, for example.

The solution may be based on one or more variables of the project defined by the user in combination with one or more assumptions of the energy savings and cost estimation tool. To determine the energy savings of a potential solution, the energy savings and cost estimation tool may calculate the existing energy usage (e.g., existing lighting energy usage) of the project, for example, on a zone by zone basis and/or on a period by period basis. The energy savings and cost estimation tool may also calculate an estimate of energy usage (e.g., lighting energy usage) used by the project after a proposed solution is implemented, for example, on a zone by zone basis and/or on a period by period basis. The energy savings and cost estimation tool may then compare the estimate of the existing energy usage with the estimated energy usage of the proposed solution (e.g., proposed energy usage) to generate the energy savings that a customer may realize if the solution is implemented at their project site.

As described herein, the energy savings and cost estimation tool may calculate the existing and proposed energy usage of a project using high level variables (e.g., the project information define by the user using the energy savings and cost estimation tool) along with one or more underlying assumptions. The assumptions may be generated by the energy savings and cost estimation tool using the defined project information of the current project and information from one or more databases. For example, an assumption may be calculated by the energy savings and cost estimation tool utilizing information from one or more databases (e.g., existing project information) along with defined project information of the current project. The energy savings and cost estimation tool may allow a user who does not have the means (e.g., the knowledge, the equipment, etc.) for determining the required formulas and all the necessary variables required by the formulas to determine an accurate estimate of the energy savings of the project if the proposed solution were implemented.

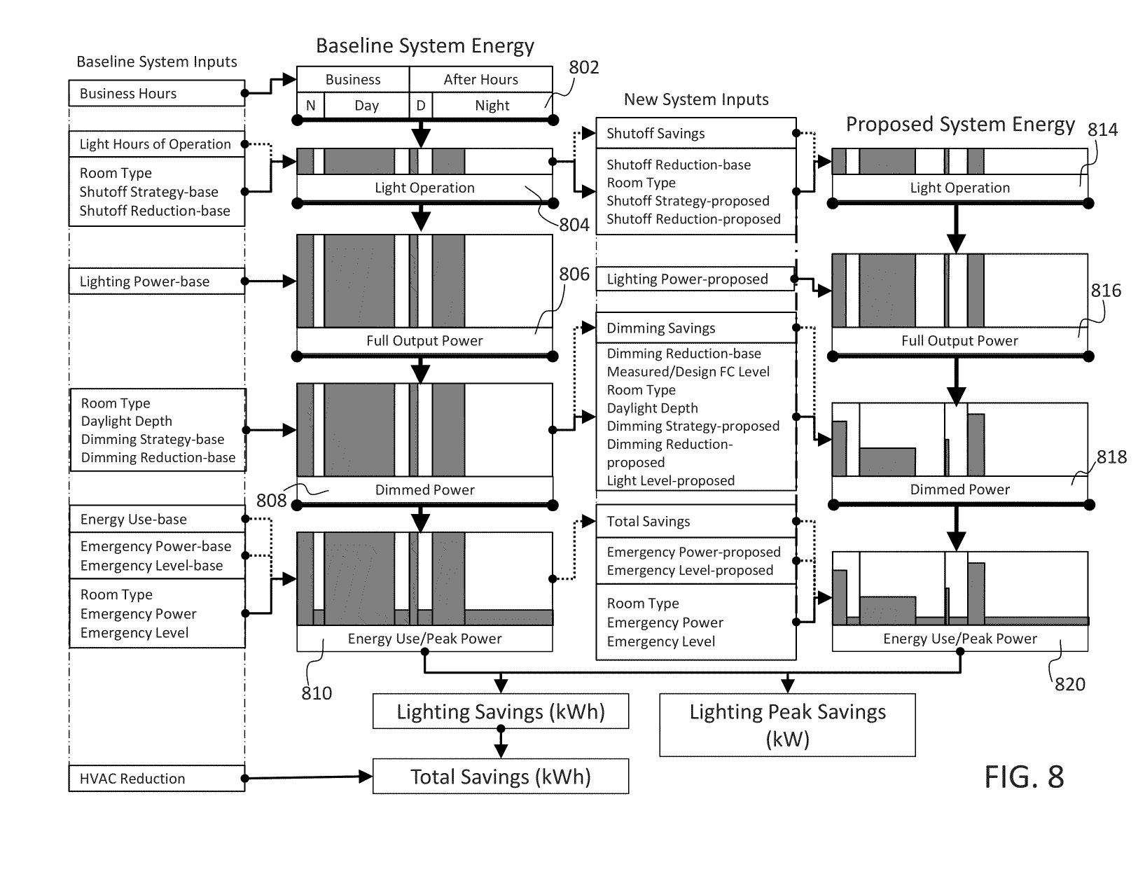

The energy savings variables and/or the underlying assumptions may be calculated on a periodic basis, such as a yearly basis, for example. Further, as described in more detail herein, the energy savings and cost estimation tool may break down one or more energy savings variables and/or assumptions on a periodic basis. For example, the energy savings and cost estimation tool may break down the year into a plurality of different periods (e.g., discrete time periods), whereby each period may include a different energy profile, such as a different lighting profile, for example. For example, the energy savings and cost estimation tool may define four different periods, such as, business hours with daylight, business hours without daylight, afterhours with daylight, and after hours without daylight (e.g., as shown in FIG. 8). The energy savings and cost estimation tool may define a peak period that may be characterized by a time period where peak energy costs may be applied (e.g., 1-4 pm). The energy savings and cost estimation tool may determine the energy savings variables and/or the assumptions of the project for each period defined. By calculating the energy savings variables and/or the assumptions for each period, the energy savings and cost estimation tool may provide a more accurate solution for a project.

Further, the energy savings and cost estimation tool may determine one or more of the energy savings variables and/or define one or more of the underlying assumptions on a room-by-room and/or zone-by-zone basis. Therefore, as described herein, for each defined period, the energy savings and cost estimation tool may determine one or more of the energy savings variables and/or define one or more of the underlying assumptions for each zone of each room of the project. The energy savings variables and/or the assumptions determined by the energy savings and cost estimation tool may be broken down by period and further by room/zone.

As described herein, a solution may include one or more of a proposed lighting strategy, a bill of material (BOM), an implementation cost, a return on investment metric, and energy savings. The implementation cost may be generated according to labor information from the database and the BOM. The energy savings may be generated according to the baseline energy profile, the proposed energy profile, and the proposed lighting strategy. The return on investment metric may be generated according to the energy savings, the implementation cost, and energy pricing information from the database.

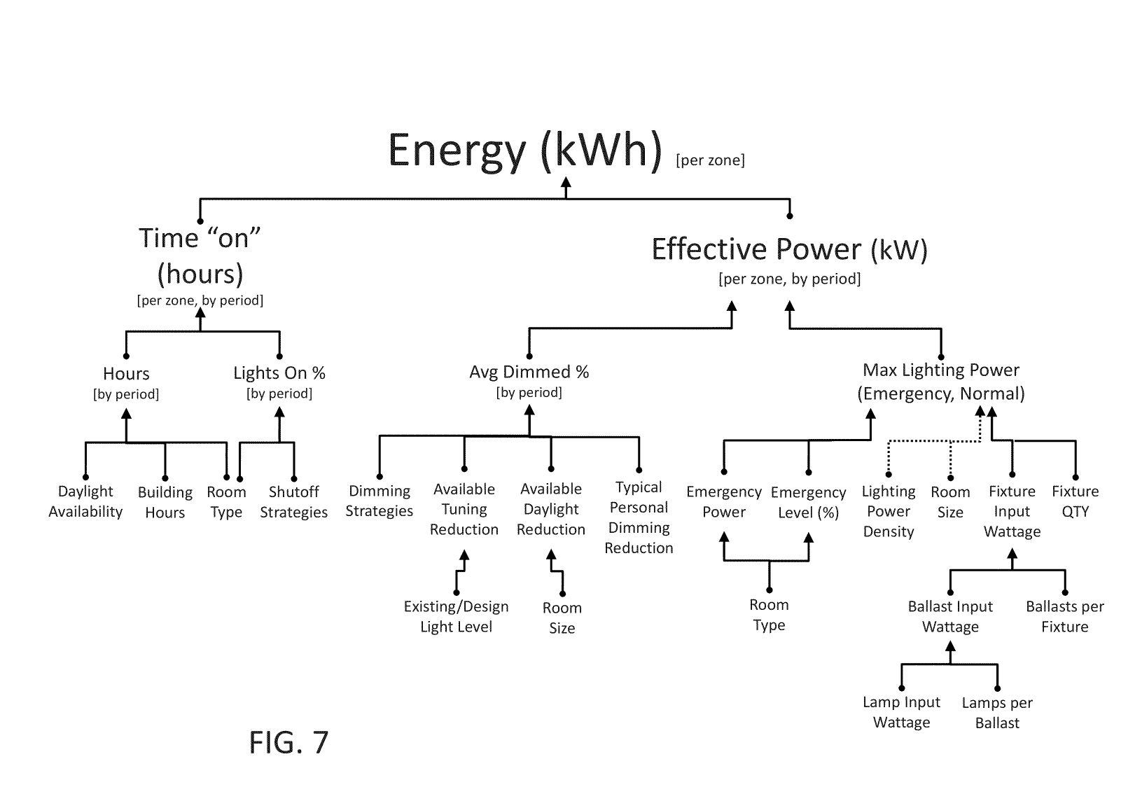

FIG. 7 is a diagram illustrating an example of energy savings variables. The diagram of FIG. 7 illustrates an example of how energy usage may be calculated by the energy savings and cost estimation tool for a project using one or more energy savings variables. The energy usage may be calculated in kilowatt hours (kWh), for example. The energy usage may be determined on a project basis, a building basis, a room basis, and/or a zone basis (e.g., as shown in FIG. 7). The energy savings and cost estimation tool may calculate energy usage, such as existing energy usage or proposed energy usage of a project, for example, by calculating the on time of the lighting of the project and the effective power (e.g., in kW) of the loads of the project. The energy savings and cost estimation tool may multiple the on time by the effective power to determine the energy usage of the project.

To determine the on time, the energy savings and cost estimation tool may determine the project hours and a lights-on percentage for the project. The on time may be determined on a per zone, per period basis. The on time may be determined in hours (h). The project hours may be the number of hours that the lighting within the project is on for a given year. The lights-on percentage may be the percentage of the project lighting that is on at a time. The energy savings and cost estimation tool may determine the project hours and the lights-on percentage for each defined period of the project and/or for each zone (or room) of the project. The project hours and/or the percentage of lights on may be different for each period and/or for each zone (or room) of the project. To determine the project hours and the lights-on percentage for the project, the energy savings and cost estimation tool may determine one or more variables, such as, for example, daylight availability, building hours (e.g., on a yearly basis), room type, shutoff strategies, etc.

The energy savings and cost estimation tool may determine the project hours based on one or more energy savings variables, such as, the daylight availability, the building hours of the project (e.g., on a yearly basis), and the room type(s) of the project, for example. The energy savings and cost estimation tool may determine the energy savings variables on a zone-by-zone (or room-by-room) basis and/or on a period-by-period basis. For example, the daylight availability may be determined based on whether or not a room is defined as having windows, the size of the room, the room type, and/or the period. The building hours may be determined based on the total building hours and/or underlying assumptions of the room type and/or the period. The room type may be defined by the user and may include underlying assumptions associated therewith. The project hours may be characterized by an estimate of the number of hours that lights are on in each zone (or room) of the project

The energy savings and cost estimation tool may determine the lights on percentage based on one or more energy savings variables, such as, the room type(s) of the project and the shutoff strategies, for example. The energy savings and cost estimation tool may determine the energy savings variables on a zone-by-zone (or room-by-room) basis and/or on a period-by-period basis. For example, the room type may be defined by the user and may include underlying assumptions associated therewith. The shutoff strategies may be determined based on user defined shutoff strategies per zone (or room), the room type, and/or the period. The shutoff strategies may include a switch, a timeclock, an occupancy sensor, a vacancy sensor, etc., and any combination therein.

As described herein, the energy savings and cost estimation tool may determine the project hours for each zone (or room) and for each period. Similarly, the energy savings and cost estimation tool may determine the lights on percentage for each zone (or room) and for each period. The energy savings and cost estimation tool may multiply the project hours by the lights on percentage for each zone (or room) and each period to determine the time on for each zone (or room) and for each period. By determining the energy savings variables for each zone (or room) and for each period of a project, the energy savings and cost estimation tool may more accurately determine the existing energy usage and the proposed energy usage of the project. Further, by utilizing underlying assumptions based on room type, period, etc., the energy savings and cost estimation tool may allow for a user to define only high level variables and still generate an accurate estimate of energy usage.

To determine the effective power, the energy savings and cost estimation tool may determine an average dimmed percentage and a maximum lighting power. The effective power may be determined on a per zone, per period basis. The effective power may be determined in kilowatts (kW). The average dimmed percentage may be the average amount of time that zone is dimmed. The maximum lighting power may be the amount of power used by the fixtures of a zone if the zone is on all the time. The maximum lighting power may be include an emergency maximum lighting power and a normal maximum lighting power. The emergency maximum lighting power may be the amount of power used by the fixtures of a zone during emergency operating conditions. The normal maximum lighting power may be the amount of power used by the fixtures of a zone during normal operating conditions.

The energy savings and cost estimation tool may determine the average dimmed percentage and the maximum lighting power for each defined period of the project and/or for each zone (or room) of the project. The average dimmed percentage and/or the maximum lighting power may be different for each period and/or for each zone (or room) of the project. To determine the average dimmed percentage and/or the maximum lighting power for the project, the energy savings and cost estimation tool may determine one or more variables, such as, for example, dimming strategies, available tuning reduction, available daylight reduction, personal dimming reduction, light level, room size, emergency power, emergency level (%), lighting power density, fixture input wattage, fixture quantity, ballast input wattage, ballasts per fixture, lamps per ballast, lamp input wattage, room type, etc.

The energy savings and cost estimation tool may determine the average dimmed percentage based on one or more energy savings variables, such as, the dimming strategies, the available tuning reduction, the available daylight reduction, the personal dimming reduction, the light level, the room size, and the room type(s) of the project, for example. The energy savings and cost estimation tool may determine the energy savings variables on a zone-by-zone (or room-by-room) basis and/or on a period-by-period basis. The average dimmed percentage may be the average amount of time that zone is dimmed.

The dimming strategies may be determined based on the control type and/or sensors of a zone or a room, such as a dimming control type and/or daylight harvesting, for example. The dimming strategies may be the existing strategies of the project or those proposed for the project. The available tuning reduction maybe determined based on the light level, for example, the existing light level or a designed light level. The light level may be determined based the defined room type, a calculated existing light level, whether or not the room has windows, the fixture type, an underlying assumption, and/or other project information.

The available daylight reduction may be determined based on the room size, the room type, whether the room has windows, the control type and/or sensors defined by the user, an underlying assumption, and/or other project information. The room size may be defined by the user and/or determined by the selected room type. The personal dimming reduction may be determined based on the room type, an underlying assumption (e.g., an estimate of typical personal dimming for that particular room type), and/or other project information.

The energy savings and cost estimation tool may determine the maximum lighting power based on one or more energy savings variables, such as, the emergency power, the emergency level (%), the lighting power density, the fixture input wattage, the fixture quantity, the ballast input wattage, the ballasts per fixture, the lamps per ballast, the lamp input wattage, the room type, etc. The maximum lighting power may be the amount of power used by the fixtures of a zone if the zone is on all the time. The maximum lighting power may be include an emergency maximum lighting power and a normal maximum lighting power. The emergency maximum lighting power may be the amount of power used by the fixtures of a zone during egress operating conditions. The normal maximum lighting power may be the amount of power used by the fixtures of a zone during normal operating conditions.

The normal maximum lighting power may be determined based on the fixture input wattage, the quantity of fixtures (e.g., per zone), the room size, the lighting power density, for example. The fixture input wattage may be the rated wattage of a fixture of a zone, such as an existing fixture defined by the user or a proposed fixture, for example. The quantity of fixtures may be the total number of fixtures per zone (or room), such as the total existing number of fixtures defined by the user or the proposed number of fixtures, for example. The normal maximum lighting power may be determined by multiplying the fixture input wattage by the quantity of fixtures of each fixture input wattage.

The normal maximum lighting power may be determined further based on the room size and the lighting power density. The room size and the lighting power density may be optional inputs. The room size may be determined based on a user defined room size and/or the room type. The lighting power density may be determined based on a user defined lighting power density or an underlying assumption. By determining the normal maximum lighting power based further on the room size and the lighting power density, the energy savings and cost estimation tool may more accurately determine the maximum lighting power of the project.

The energy savings and cost estimation tool may determine the fixture input wattage based on the ballast input wattage and the ballasts per fixture. For example, a fixture may include more than one ballast, and each ballast of a fixture may have a different input wattage. Further, the energy savings and cost estimation tool may determine the ballast input wattage based on the lamp input wattage and the number of lamps per ballast. Similarly, a ballast of a fixture may include more than one lamp, and each lamp may have a different input wattage. The energy savings and cost estimation tool may determine the ballast input wattage, the number of ballasts per fixture, the lamp input wattage, and the number of lamps per fixture based on the user defined project information or based on a proposed solution.

The energy savings and cost estimation tool may also determine an emergency maximum lighting power. Some rooms, for example based on room type, building type, etc., may include an emergency lighting level. The emergency lighting level may be characterized by times when a light switch in the room (or zone) is turned off, but the lights remain on to a low light level for emergency purposes. For example, in some building types (e.g., hospitals), some rooms (and in turn zones), such as hallways, for example, may have to remain on at all times for emergency purposes. The energy savings and cost estimation tool may take emergency lighting levels into consideration when determining energy savings information.

The emergency maximum lighting power may be determined based on the emergency power level and emergency lighting level. The emergency power level may be the maximum power used by the fixtures that might be utilized during an emergency lighting setting. The emergency power level may be based on the fixtures, ballasts, and/or lamps within a zone in combination with assumptions based on the room type. The emergency lighting level may refer to a percentage of light output that the fixtures of a zone are set to under an emergency lighting setting. The emergency lighting level may be based on an assumption relating to user defined information, room type information, and/or the required, suggested, or typical lighting level of a particular room type under an emergency lighting setting.

After determining the average dimmed percentage and the maximum lighting power, the energy savings and cost estimation tool may determine the effective power (kW) used per zone and per period of a project. Upon determining the effective power used per zone and per period of a project, the energy savings and cost estimation tool may multiple the effective power used by each zone and during each period by the time on by each zone and during each period to determine the energy usage of each zone during each period. The energy savings and cost estimation tool may add the energy usage of each period of a zone together to arrive at an estimate of the energy usage of a zone of a project. The energy savings and cost estimation tool may perform these calculations for both the existing project and the proposed solution of the project. For example, the energy savings and cost estimation tool may subtract the energy usage of the solution from the existing energy usage to determine the energy savings of the project. Therefore, the energy savings and cost estimation tool may determine the energy usage saving of a project if the proposed solution is implemented.

FIG. 8 is a diagram illustrating an example of how the energy savings and cost estimation tool may generate a solution for a project based on the defined project variables. As described herein, the energy savings and cost estimation tool may break a project year down into a plurality of periods to more accurately calculate energy usage and energy savings. For example, as shown in FIG. 8, the energy savings and cost estimation tool may break the project year down into four periods 802, which may include a business hours without daylight period (N), a business hours with daylight period (Day), an afterhours without daylight period (Night), and an afterhours with daylight period (D). A fifth period, the peak period (not shown), may be included.

User defined information about the project, the project type, the project location, and/or underlying assumptions may be utilized by the energy savings and cost estimation tool when determining the periods of a project. For example, for a building located in the northeast of the United States, the business hours may be defined as 8 am to 6 pm, Monday through Friday, and the afterhours may be defined as 6:01 pm-7:59 am, Monday through Friday, and all day Saturday and Sunday. Daylight may be estimated based on the sunrise and sunset for the location of the project over a number of previous years. The business hours may be determined based on project information defined by the user input and/or underlying assumptions (e.g., assumptions relating to the typical business hours of the project building type, for example, according to data stored within the one or more databases). The business hours without daylight period may be characterized by those times in a year during the standard business hours (e.g., 8 am-6 pm) when there is not daylight, such as from 5 pm-6 pm in the winter months, for example. The business hours with daylight period may be characterized by those times in the year during the standard business hours when there is daylight, such as from 8 am-5 pm in the winter months and Sam-6pm in the spring, summer, and fall months, for example. The afterhours without daylight period may be characterized by those times in the year after business hours (e.g., 6:01 pm-7:59 am) when there is not daylight, such as from 6:01 pm-7 am in the winter months and 8:30 pm-6 am in the summer months on Monday through Friday and sunset to sunrise on Saturday and Sunday, for example. The afterhours with daylight period may be characterized by those times in the year after business hours where there is daylight, such as from 6:01 pm-8:30 pm and 6 am-8 am in the summer months and 7 am-8 am in the winter months, and sunrise to sunset on Saturday and Sunday.

The energy savings and cost estimation tool may utilize project information defined by the user along with one or more underlying assumptions to determine the energy usage and energy savings of a project. For example, for a lighting retrofit project (e.g., as shown in FIG. 8), the energy savings and cost estimation tool may utilize project information, such as, the business hours, the buildings, the room(s), the zone(s), the room size, whether a room has windows, the room type, the fixtures (e.g., the existing fixtures for the baseline determination), the controls, the sensors, the dimming strategies, the shutoff strategies, heating, ventilating, and air conditioning (HVAC) information, etc. The energy savings and cost estimation tool may determine the project information as described herein, for example, the project information may be defined by the user, based solely on an underlying assumption, and/or based on an underlying assumption in combination with other defined project information. For example, the energy savings and cost estimation tool may also utilize one or more underlying assumptions based on the room type. The energy savings and cost estimation tool may make room type assumptions, such as the shutoff energy reduction, the dimming energy reduction, the emergency power level, the emergency lighting level, etc., on a room by room basis based on the defined room type.

Some of the project information utilized by the energy savings and cost estimation tool may include optional override inputs, for example, those described herein. Optional override inputs may refer to project information that the user may define, but does not have to define for the project. If the user defines an optional override input, then the energy savings and cost estimation tool may utilize the user defined input. If the user does not define an optional override input, then the energy savings and cost estimation tool may make an assumption estimating the input based on other project information, such as room type, for example. The assumption may be made using information on existing/predefined projects within the one or more databases, for example, as described herein.

The energy savings and cost estimation tool may calculate a baseline (or existing) system energy profile 810, which may provide the existing energy usage of the project. To determine the baseline system energy profile 810, the energy savings and cost estimation tool may define one or more periods 802. For example, in FIG. 8, the energy savings and cost estimation tool may define four periods, such as a business hours without daylight period, a business hours with daylight period, an afterhours without daylight period, and an afterhours with daylight period.

The energy savings and cost estimation tool may utilize project information to determine the light operation profile 804 of the project. For example, the project information may include the room type, the shutoff strategy, the shutoff reduction, the light hours of operation (e.g., which may be optional), etc. The light operation profile 804 of the project may relate to a breakdown of the operation of the project lighting across the defined periods 802. For example, as shown in FIG. 8, the shaded area of the light operation profile 804 may represent the time that the project lights are operating (e.g., on) during a period, and the non-shaded area of the light operation profile 804 may represent the time that the project lights are not operating (e.g., off) during the period. For example, the wider the shaded area in the light operation profile 804, then the more time the project lights are on during that period.

The energy savings and cost estimation tool may determine a full output power profile 806 of the project, for example, based on the light operation described above and/or based on project information. For example, the project information may include the room(s), the zone(s), the room size, the room type, the fixtures (e.g., the existing fixtures of the current project for the baseline determination), etc. The full output power profile 806 of the project may relate to a breakdown of the total power used by the project lighting across the defined periods. The full output power profile 806 may provide a light powered base for the project. The full output power profile 806 may represent an estimate of the lighting energy use in each period assuming the lights are on at full during each period. For example, as shown in FIG. 8, the shaded area of the full output power profile 806 may represent the time and amount of power that the project lights are operating during the period, and the non-shaded area of the full output power profile 806 may represent the time that the project lights are not operating during the period. For example, the taller the shaded area of the full output power profile 806, then the greater amount of power used by the project lights during that period.

The energy savings and cost estimation tool may determine a dimmed power profile 808 of the project, for example, based on the full output power described above and/or based on project information. For example, the project information may include the room(s), the zone(s), the room size, the room type, the fixtures (e.g., the existing fixtures for the baseline determination), dimming strategies, controls, sensors, whether the room has windows, etc. The dimmed power profile 808 of the project may relate to a breakdown of the total power used by the project lighting across the defined periods, further taking into consideration the dimming strategies implemented and their effect on energy usage. For example, as shown in FIG. 8, the shaded area of the dimmed power profile 808 may represent the time and amount of power that the project lights are operating during the period taking into consideration the dimming strategies used, and the non-shaded area of the full output power profile 808 may represent the time that the project lights are not operating during the period. As shown in FIG. 8, for example, the dimmed power of the baseline system energy profile may not utilize any dimming strategies, which is why the dimmed power profile 808 and the full output power profile 806 appear the same. The dimmed power profile 808 may represent an estimate of the lighting energy use in each period taking into consideration any dimming strategies.

The energy savings and cost estimation tool may determine the energy usage profile 810 of the project, for example, based on the dimmed power described above and/or based on project information. For example, the project information may include the room(s), the zone(s), the room size, the room type, the fixtures (e.g., the existing fixtures for the baseline determination), dimming strategies, controls, sensors, whether the room has windows, emergency power information, etc. The energy usage profile 810 of the project may relate to a breakdown of the dimmed power used of the project lighting across the defined periods, further taking into consideration the emergency lighting strategies implemented and their effect on total power. For example, as shown in FIG. 8, the shaded area of the energy usage profile 810 may represent the time and amount of power that the project lights are operating during the period taking into consideration the emergency lighting strategies implemented. As shown in FIG. 8, for example, there may no longer be any non-shaded areas in the energy usage profile 810 since the project may utilize an emergency lighting strategy for periods of time when lighting may be set to off.

The energy usage profile 810 may be representative of the existing power usage (e.g., the lighting power usage) of the project. If a user were to change project information in the energy savings and cost estimation tool, then the energy usage profile 810 may be changed by the energy savings and cost estimation tool to represent those changes. Therefore, the energy usage profile 810 may be considered a learning profile that changes as the project information is changed.

The energy savings and cost estimation tool may determine a solution, for example, as described herein. The energy savings and cost estimation tool may determine an energy usage profile 820 representative of a proposed energy usage according to the solution. The energy savings and cost estimation tool may utilize the same defined periods 802 for the proposed system energy profile as was used for the baseline system energy profile. For example, the energy savings and cost estimation tool may utilize the existing energy usage profile 810 as a baseline for the proposed energy usage profile 820, and adapt the existing energy usage profile 810 in accordance with the define project information and/or proposed solution to generate the proposed energy usage profile 820.

As shown in FIG. 8, for example, the energy savings and cost estimation tool may determine a light operation profile 814 of the proposed solution in a manner similar to as described above with reference to the baseline system. However, the energy savings and cost estimation tool may utilize project information of the existing system, project information of the proposed solution, and/or underlying assumptions to determine the light operation profile 814. The energy savings and cost estimation tool may determine the light operation profile 814 based on the existing (baseline) shutoff reduction, proposed shutoff strategies, proposed shutoff reduction, shutoff saving, room type, etc. For example, the energy savings and cost estimation tool may start with the baseline profile (e.g., baseline light operation profile) and make adaptations to the baseline profile based on one or more proposed strategies of a solution, for example, to determine the energy use profile 820 of the proposed solution.

The energy savings and cost estimation tool may determine a full output power profile 816 of the proposed solution in a manner similar to as described above with reference to the baseline system. However, the energy savings and cost estimation tool may utilize project information of the existing system, project information of the proposed solution, and/or underlying assumptions to determine the full output power profile 816. For example, the energy savings and cost estimation tool may determine the full output power profile 816 based on the proposed fixtures of the solution.

The energy savings and cost estimation tool may determine a dimmed power profile 818 of the proposed solution in a manner similar to as described above with reference to the baseline system. However, the energy savings and cost estimation tool may utilize project information of the existing system, project information of the proposed solution, and/or underlying assumptions to determine the dimmed power profile 818. For example, the energy savings and cost estimation tool may determine the dimmed power profile 818 based on the existing (baseline) dimming reduction, the measured or designed foot candle level, the room type, whether or not a room has windows, the distance from the window to the deepest part of the room, the proposed dimming strategy, the proposed dimming reduction, the proposed light level, the dimming savings, etc.

The energy savings and cost estimation tool may determine the energy usage profile 820 of the proposed solution in a manner similar to as described above with reference to the baseline system. However, the energy savings and cost estimation tool may utilize project information of the existing system, project information of the proposed solution, and/or underlying assumptions to determine the energy usage profile 820. For example, the energy savings and cost estimation tool may determine the energy usage profile 820 based on the proposed emergency power level, the proposed emergency lighting level, the room type, the total savings, etc.

The energy usage profile 820 may be representative of an estimation of the power usage (e.g., the lighting power usage) of the proposed solution for the project. If a user were to change project information in the energy savings and cost estimation tool, then the solution may be changed, and in turn the energy usage profile 820 may be changed by the energy savings and cost estimation tool. Therefore, the energy usage profile 820 may be considered a learning profile that changes as the project information is changed.

Using the existing energy usage profile 810 and the proposed energy usage profile 820 of the solution, the energy savings and cost estimation tool may determine the lighting savings (kWh), the lighting peak savings (kW), and/or the total savings (kWh) of the solution for the project. The energy savings and cost estimation tool may determine any of the profiles described with reference to FIG. 8 on a project level, a building level, a floor level, a room level, and/or a zone level.

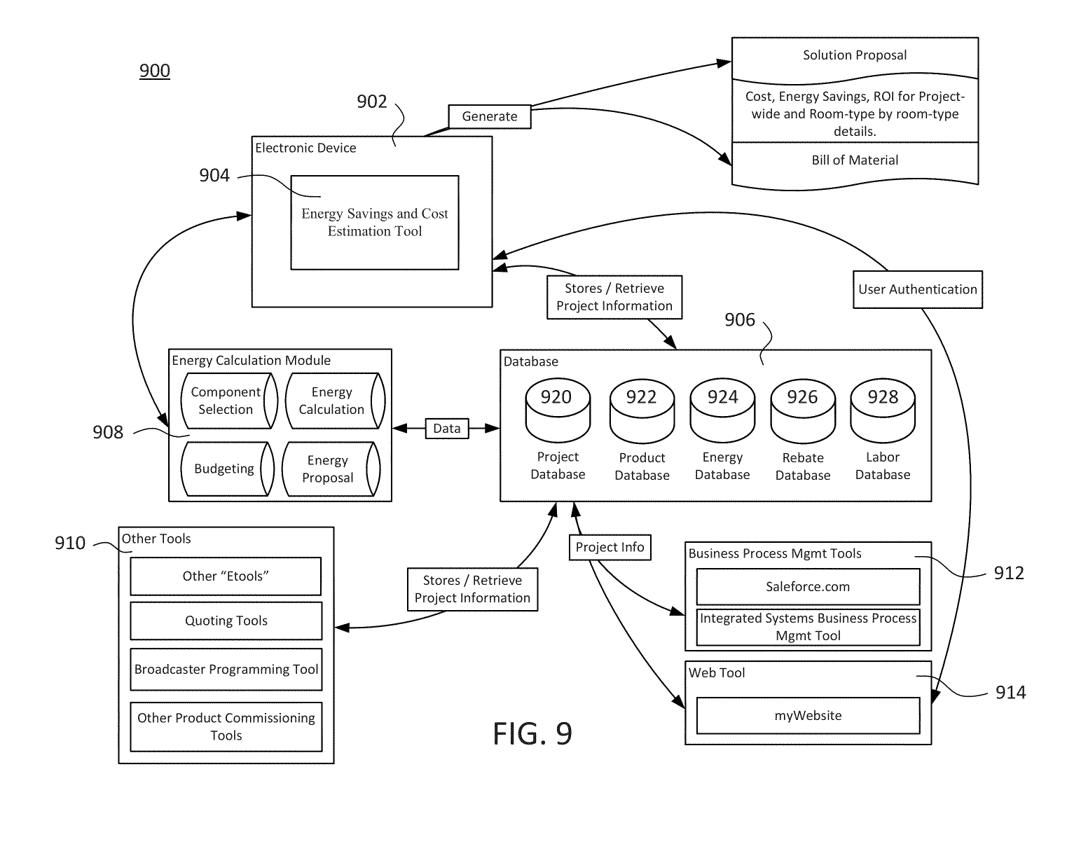

FIG. 9 is a diagram illustrating an example of a system that includes an energy savings and cost estimation tool and one or more databases. The system 900 may comprise an electronic device 902, an energy savings and cost estimation tool 904 residing on the electronic device 902, a database 906, an energy calculation module 908, other tools 910, business process management tools 912, and web tools 914. The system 900 and its components may communicate via a wired and/or wireless communication link, such as, a local area network (LAN), the Internet, a radio technology (e.g., UTRA, E-UTRA, etc.), a cellular based radio technology (e.g., WCDMA, LTE, LTE-A, etc.), WiFi (e.g., an IEEE 802.11 protocol), etc., for example. The system 900 may be the same as the system 100.

The electronic device 902 may be similar to the electronic device 280 of FIG. 1. The electronic device 902 may be a personal computer (PC) or a mobile electronic device, such as a laptop computer, tablet, or a smart phone, for example. The energy savings and cost estimation tool 904 may reside on the electronic device 902.

The energy savings and cost estimation tool 904 may be implemented on the electronic device 902. For example, the energy savings and cost estimation tool 904 may be a mobile application. As described herein, the energy savings and cost estimation tool 904 may create a project (e.g., a new or a retrofit lighting project). The energy savings and cost estimation tool 904 may receive project information relating to the current project as defined by a user. The energy savings and cost estimation tool 904 may store the project information defined by the user for the project in the database 906. The energy savings and cost estimation tool 904 may retrieve project data relating to other existing projects from the database 906. The energy savings and cost estimation tool 904 may utilize the project information defined by the user, the project information (e.g., existing project information relating to existing projects) retrieved from the database 906, and/or one or more assumptions to generate a solution for the project (e.g., via the energy calculation module 908, for example, as described herein). The energy savings and cost estimation tool 904 may be configured to dynamically change default and prepopulated fields within the database 906 (e.g., the project database 920).

The database 906 may comprise one or more databases. For example, the database 906 may comprise one or more of a project database 920, a product database 922, an energy database 924, a rebate database 926, and a labor database 928. For example, the database 906 may be similar to the cost database 220, the rebate and building codes database 230, the labor database 240, the product database 250, the energy database 260, and/or the installed project database 270 of system 200. The database 960 may be dynamically updated.

The database 960 may be populated by the energy savings and cost estimation tool 904, by other components of the system 900, and/or by a third party. For example, the database 906 may receive and store information (e.g., project information for a current project) from the energy savings and cost estimation tool 904. The database 906 may receive and store information (e.g., existing project information) from the business process management tools 912, the web tool 914, and the other tools 910. The database 906 may send data (e.g., raw energy data, project data, etc.) to the energy calculation module 908.

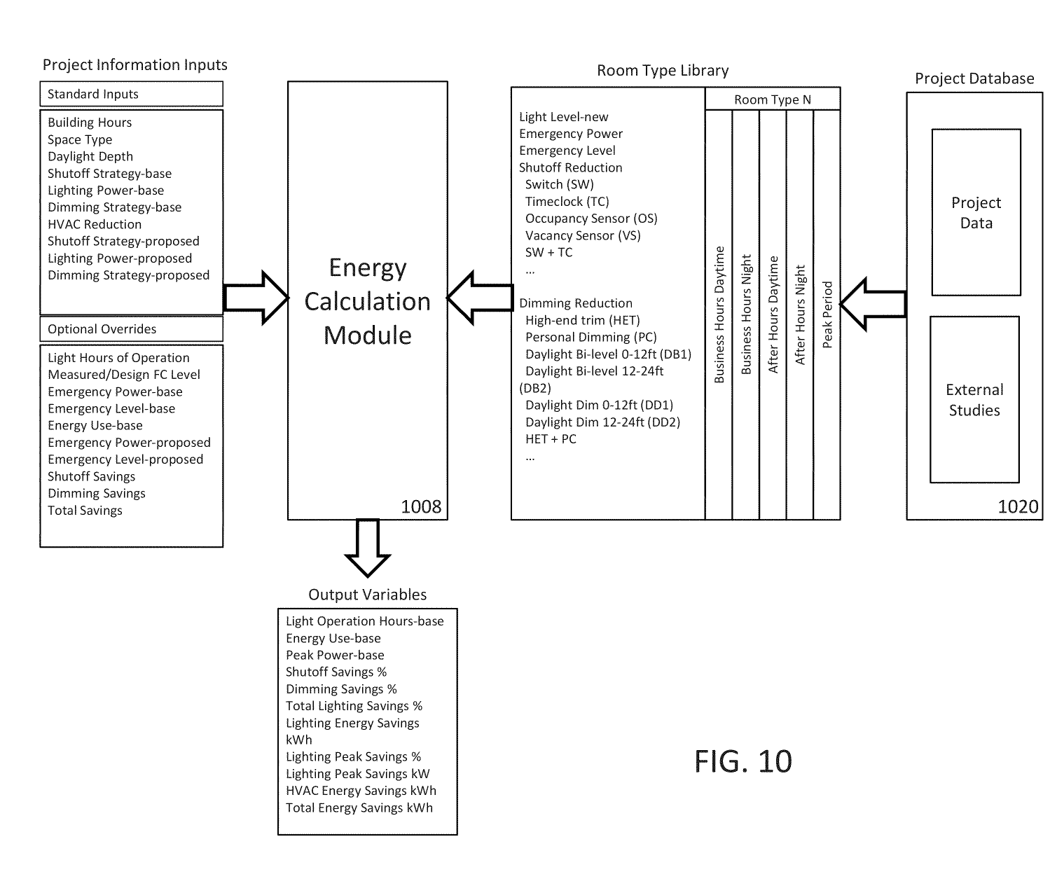

The project database 920 may comprise project information (e.g., as described herein) relating to projects, such as the current project and/or existing projects, for example. The existing projects may include projects in which project information has previously been defied by a user and stored in the project database 920. For example, existing projects may include projects in which a solution was already generated for by the energy savings and cost estimation tool 904. However, existing projects may include projects that did not utilize the energy savings and cost estimation tool 904. The project information may be broken down based on project type, room type, room size, number of zones, components (e.g., fixtures, switches, sensors, etc.), operating hours, etc. For example, as described with reference to FIG. 10, the project information may be broken down based on room type, then period, and then energy strategy. Breaking down the project information may provide for additional granularity and accuracy in the solution generated by the energy savings and cost estimation tool 904 (e.g., and the assumptions made by the energy calculation module 1008).

The product database 922 may comprise information relating to products. The products may include fixtures, lamps, controls, sensors, accessories, etc. The products may be products of an existing project, of the existing project (e.g., the project currently being defined by the energy savings and cost estimation tool 904), and/or products of a specific manufacture(s). The product information may include information relating to the size of the product, the cost of the product, the energy efficiency of the product, the compatibility of the product with other components, etc.

The energy database 924 may comprise information relating to energy usage. The energy usage information may include raw energy usage information. The energy usage information may be characterized by any of the project information described herein, such as project type, building, room type, room size, number of zones, whether or not a room has windows, fixtures, lamps, controls, sensors, accessories, etc., for example. The energy usage may be broken down on the project, building, room, zone, fixture, or component level. The energy usage information may be characterized by specific combinations of project information. For example, the energy usage information may be characterized by a combination of room type, room size, fixture type, and control type. The energy usage information may be utilized by the energy savings and cost estimation tool 904 (e.g., via the energy calculation module 908) to determine estimated energy usage of an existing project and a proposed solution. Further, the energy usage information may be utilized by the energy savings and cost estimation tool 904 (e.g., via the energy calculation module 908) to determine one or more solutions for a project.

The rebate database 926 may comprise rebate information. The rebate database 926 may include rebate requirements relating to the type of rebates available for a project, the amount of the rebate, any rebate requirements (e.g., fixture requirements, power requirements, etc.), etc. For example, the rebate database 960 may comprise rebate information for lighting controls and/or lighting fixtures. The rebate database 960 may comprise local codes, regulations, requirements. The rebate database 926 may also include utility rebates that may relate to electricity rates of the project. The energy savings and cost estimation tool 904 may determine the utility rebate for a project based on the location of the project. The energy savings and cost estimation tool 904 may utilize the rebate information when determining at solution for a project and a cost for a solution for a project.

The labor database 928 may include information relating to labor rates for the installation of a solution (e.g., the components of the solution). For example, the labor database 928 may comprise a plurality of trained contractors and their associated rates. The system 900 may include a labor portal that is configured to allow contractors to enter in their labor rates (e.g., by location) into the labor database 928. The labor portal may be configured to allow for contractors to bid on projects in real-time.

The energy calculation module 908 may determine the associated costs, the energy calculations, the one or more strategies, and/or the proposed components of a solution for a project. The energy calculation module 908 may reside (e.g., partially reside) on a server (e.g., as shown in FIG. 9) and/or may reside (e.g., partially reside) within the energy savings and cost estimation tool 904. For example, the energy calculation module 908 may be implemented within the energy savings and cost estimation tool 904. For example, the energy calculation module 908 may be implemented partially within a server and partially within the energy savings and cost estimation tool 904. The energy savings and cost estimation tool 904 may instruct the energy calculation module 908 to make determinations, to provide information, to generate strategies, and/or to generate a solution for a project.

The energy calculation module 908 may comprise a component selection module, an energy calculation module, a budgeting module, and an energy proposal module. The component selection module may determine one or more components (e.g., sensors, controls, fixtures, accessories, etc.) for one or more strategies of a solution for the project. The energy calculation module may determine an estimate of the energy usage of an existing project. The energy proposal module may determine an estimate of the energy usage of a proposed solution to the project. For example, the energy calculation module 908 may perform energy calculations, such as the energy calculations described herein with respect to FIGS. 7 and 8. The budgeting module may determine the cost associated with implementing a proposed solution (e.g., the strategies within a solution) for a project. The energy calculation module 908 may comprise logic to determine and propose a most efficient solution(s) for the project. Efficiency may be determined on the basis of cost, energy usage, rate of return, etc., or any combination thereof. The energy calculation module 908 may determine a solution based on, for example, the project information defined by the user, information from the database 906, and/or one or more assumptions. The energy calculation module 908 may provide information relating to the solution to the energy savings and cost estimation tool 904, so that the energy savings and cost estimation tool 904 may generate a proposal and bill of materials for the customer.

The energy calculation module 908 may generate one or more assumptions relating to the project, for example, using the defined project information provided by the energy savings and cost estimation tool 904 and the information provided by the database 906 (e.g., the project data, the product data, the energy data, the rebate data, etc.). An assumption may relate to a presumption that similarly situated projects experience similar energy usage, have similar characteristics (e.g., operating characteristics), etc. For example, an assumption may relate to the existing or proposed energy usage of a project, such as the energy usage of a particular zone of the project (e.g., the existing energy usage or the proposed energy usage utilizing a proposed strategy), for example. By utilizing one or more assumptions that are determined utilizing existing project information of projects that are similar to the current project, the energy calculation module 908 may accurately estimate the energy usage of the existing project and the energy usage of proposed solutions for the project. Further, the energy calculation module 908 may utilize one or more assumptions to determine a proposed solution for the project.

As described above, the energy calculation module 908 may estimate the energy usage of a zone of a project by assuming that the zone has similar energy usage as other zones of existing projects that are similarly situated. The energy calculation module 908 may determine that a zone (or room, building, etc.) is similarly situated based on the defined project information of the zone, such as the room type of the zone, the size of the room, the fixtures of the zone, whether the room has windows, the operating hours of the building, etc., for example. The energy calculation module 908 may retrieve information relating to existing projects (e.g., similar zones of the existing projects) from the database 906. The energy calculation module 908 may determine one or more assumptions relating to the zone of the project using the retrieved information relating to similar existing projects. For example, an assumption may relate to an estimation of the existing energy usage of the zone, the proposed energy usage of the zone using a proposed solution, etc. When determining an assumption, the energy calculation module 908 may take into consideration the defined project information of the zone. The energy calculation module 908 may utilize one or more assumptions and/or the project information of the zone to determine an estimate of the energy usage of the zone (e.g., the existing energy usage or the proposed energy usage utilizing a proposed strategy).

The energy calculation module 908 may determine one or more strategies (e.g., lighting control strategies) for a solution to a project, for example, by comparing assumptions relating to existing and proposed energy usage (e.g., on a zone-by-zone basis). For example, the energy calculation module 908 may determine a proposed strategy for a zone of a project by comparing different proposed strategies (e.g., different combinations of fixtures, sensors, controls, etc.) for the zone. The energy calculation module 908 may determine an estimate of the energy usage of one or more different strategies by assuming that similarly situated rooms have similar energy usage characteristics. As noted above, the energy calculation module 908 may determine that a zone (or room, building, etc.) is similarly situated based on the defined project information of the zone, such as the room type of the zone, the size of the room, the fixtures of the zone, whether the room has windows, the operating hours of the building, etc., for example. The energy calculation module 908 may use existing information from the database 906 to estimate how the zone will react to different strategies. The energy calculation module 908 may determine estimates for energy usage of different strategies for the zone. The energy calculation module 908 may determine the one or more strategies that provide for the most efficient solution(s) for the project.

The other tools 910 may include tools utilized by the energy savings and cost estimation tool 904, the energy calculation module 908, and/or the database 906. For example, the other tools may include electronic tools, quoting tools, broadcaster programming tool, etc. The other tools 910 may store and/or retrieve information, such as project and product information, for example, in the database 906.

The business process management tools 912 may include tools utilized by the energy savings and cost estimation tool 904, the energy calculation module 908, and/or the database 906. The business management tools 912 may include a website and/or an integrated systems business process management tool that allows for company contractors to view, store, and/or retrieve information, such as project information, project information, labor information, rebates, etc., in the database 906.

The web tools 914 may include tools utilized by the energy savings and cost estimation tool 904, the energy calculation module 908, and/or the database 906. The web tools 914 may include a website that may be accessed by non-company personal (e.g., contractors) to view, store, and/or retrieve information, such as project information, project information, labor information, rebates, etc., in the database 906. The other tools 910, business management tools 912, and/or web tools 914 may assist the energy savings and cost estimation tool 904 in determining a solution for a project, for example, by supplementing the energy calculation module 908 and/or the database 906.

FIG. 10 is a diagram illustrating an example of an energy calculation module. The energy calculation module 1008 may be similar to the energy savings module 908. The energy calculation module 1008 may reside (e.g., partially reside) on an energy savings and cost estimation tool and/or may reside (e.g., partially reside) on a server. The energy calculation module 1008 may determine the associated costs, the energy calculations, the one or more strategies, and/or the proposed components of a solution for a project. FIG. 10 illustrates an example of how the energy calculation module 1008 may retrieve project information from the energy savings and cost estimation tool, retrieve existing project information from a database, such as a project database 1020, for example, and determine one or more output variables that may be utilized by the energy savings and cost estimation tool to generate a solution. The project database 1020 may be similar to the project database 920.

The energy calculation module 1008 may receive project information relating to a current project. For example, the energy calculation module 1008 may receive standard project information and optional project information. The standard project information may include, for example, one or more of the buildings hours, the room type, the room size, whether the room has windows, the existing shutoff strategies, the existing dimming strategies, the HVAC reduction, the proposed shutoff strategies, the proposed dimming strategies, etc. The optional project information may include, for example, one or more of the light hours of operation of each building of the project, the measured or designed foot candle level, the existing emergency power level, the existing emergency lighting level, the existing energy usage, the proposed emergency power level, the proposed emergency lighting level, the shutoff saving of the proposed solution, the dimming savings of the proposed solution, the total savings of the proposed solution, etc. If the energy calculation module 1008 receives optional project information, then the energy calculation module 1008 may utilize the received optional project information. However, if the energy calculation module 1008 does not receive the optional project information, then the energy calculation module 1008 may generate an assumption for the optional project information, for example, using information from the project database 1020 (e.g., as described herein).

The project database 1020 may comprise project information (e.g., as described herein) relating to projects (e.g., the current project and/or existing projects). Existing project information may relate to project information associated with one or more existing (or predefined) projects. For example, the existing project information may include one or more of energy usage of an existing project, a total number of buildings of an existing project, a total yearly operating hours of an existing project, a number of floors per building of an existing project, a number of rooms per floor of an existing project, a room type for a room of an existing project, a size of a room of an existing project, whether a room has windows, a number of zones per room of an existing project, a fixture of an existing, a lighting control of an existing, a sensor of an existing, and heating, ventilating, and air conditioning (HVAC) information of an existing project.

The project information (e.g., current project information or existing project information) may be broken down based on room type. Within each room type, the project information may be further broken down based on period. For example, the project information may be broken down based on business hours with daylight, business hours without daylight, afterhours with daylight, afterhours without daylight, and peak power. Within each period, the project information may be further broken down based on strategy type, such as full power level, shutoff reduction, dimming reduction, etc., for example. Therefore, the project database 1020 may include project information that is unique or specific for each strategy (e.g., fixture, sensor, control, etc.), within each of the defined periods, and further within each of the defined room types. Breaking down the project information, for example based on room type, and then period, and then strategy, may provide for additional granularity and accuracy in the assumptions and/or output variables of the energy calculation module 1008. Therefore, the energy savings and cost estimation tool may generate a more accurate solution for a project. Although the project information is broken down based on room type, period, and strategy (e.g., in that order), the project information may be broken down using any order and/or any combination of project information.

As described herein, the energy calculation module 1008 may determine one or more output variables that may be utilized by the energy savings and cost estimation tool to generate a solution. The output variables may include, for example, one or more of an estimate of the existing light operation hours, an estimate of the existing energy usage, an estimate of the peak power usage, an estimate of shutoff savings (%), an estimate of dimming savings (%), an estimate of the total savings (% and kW), an estimate of lighting energy savings (kW), an estimate of the peak lighting savings (% and kW), an estimate of HVAC energy savings (kW), etc. The energy savings and cost estimation tool (e.g., via the energy calculation module 1008) may determine a solution utilizing one or more output variables of the energy calculation module 1008.

As described herein, the solution may include one or more of a bill of material (BOM) for the project, a cost estimate for the project, an estimate on different return on investment metrics for the project, energy savings of the project, etc. The energy savings and cost estimation tool may provide more than one strategy within a solution, whereby each strategy may be characterized by a unique set of sensors, controls, fixtures, accessories, etc. The energy savings and cost estimation tool (e.g., via the energy calculation module 1008) may determine the different strategies based on data analysis relating to the effectiveness of different combinations of the components (e.g., sensors, controls, fixtures, accessories, etc.).

As described herein, each strategy may be characterized by a unique set of components, such as sensors, controls, fixtures, accessories, etc., for example. The energy savings and cost estimation tool may determine one or more different strategies based on data analysis relating to the effectiveness of different combinations of the components (e.g., sensors, controls, fixtures, accessories, etc.), for example, using defined project information, existing project information from a database, and/or one or more assumptions. The energy savings and cost estimation tool may compare a plurality of different combinations of components to determine those that provide the greatest benefit, the most cost effective benefit, the most energy efficient benefit, the best return on investment, etc. The energy savings and cost estimation tool may allow for a different strategy to be defined on the building level, floor level, and/or room level.

Recursive database optimization may utilize override input data to adjust assumption input data to optimize a solution. The recursive database optimization may be utilized by a tool that generates a solution, such as an energy savings and cost estimation tool, for example. For example, the energy savings and cost estimation tool may provide a solution based on high level variables. The energy savings and cost estimation tool may generate one or more assumptions based on the high level variables (e.g., project information) in order to arrive at the solution. A user may be provided with one or more of the underlying assumptions. A user may provide override input data to replace the underlying assumption data within one or more assumptions. The energy savings and cost estimation tool may then adjust the solution based on the override input data provided by the user to provide a more accurate and customized solution.

As described herein, the energy savings and cost estimation tool (e.g., via the energy calculation module) may generate one or more make assumptions. An assumption may be generated utilizing information, such as defined project information and/or stored existing project information, for example. An assumption may relate to a presumption that similarly situated projects experience similar energy usage, have similar characteristics, etc. For example, the energy savings and cost estimation tool may generate an assumption relating to optional project information (e.g., as described with reference to FIG. 10).

If the optional project information is defined by the user, then the energy savings and cost estimation tool may utilize the defined optional project information. However, if the optional project information is not defined by the user, then the energy savings and cost estimation tool may generate an assumption for the optional project information, for example, using information from a database (e.g., as described herein). The energy savings and cost estimation tool may generate a solution based on the assumption for the optional project information. However, if the user were to define the optional project information, then the energy savings and cost estimation tool may re-determine the solution.

The database (e.g., database 906 or 1020) may receive (e.g., dynamically receive) project information relating to existing projects. As the database is updated with new project information (e.g., from other current project or existing projects), the energy savings and cost estimation tool (e.g., via the energy calculation module) may re-determine the one or more assumptions, an in turn, may re-generate the solutions for the project. Therefore, the energy savings and cost estimation tool may adjust a solution based on the override input data provided by the user and/or based on additional project information in the database to provide a more accurate and customized solution for the project.

More than one user may enter project information about a project into the energy savings and cost estimation tool at a time. For example, a first user may enter project information relating to a building, floor, room, and/or zone of the project, while a second user is simultaneously entering project information relating to another building, floor, room, and/or zone of the project. If more than one user is accessing a project at a time, then the energy savings and cost estimation tool may lock users out from buildings, floors, rooms, and/or zones that are being accessed by another user. Locking out users may prevent errors that may occur if more than one user were to enter the same information at a time. Therefore, the energy savings and cost estimation tool may allow for the substantially simultaneous defining of a project by more than one user at a time.

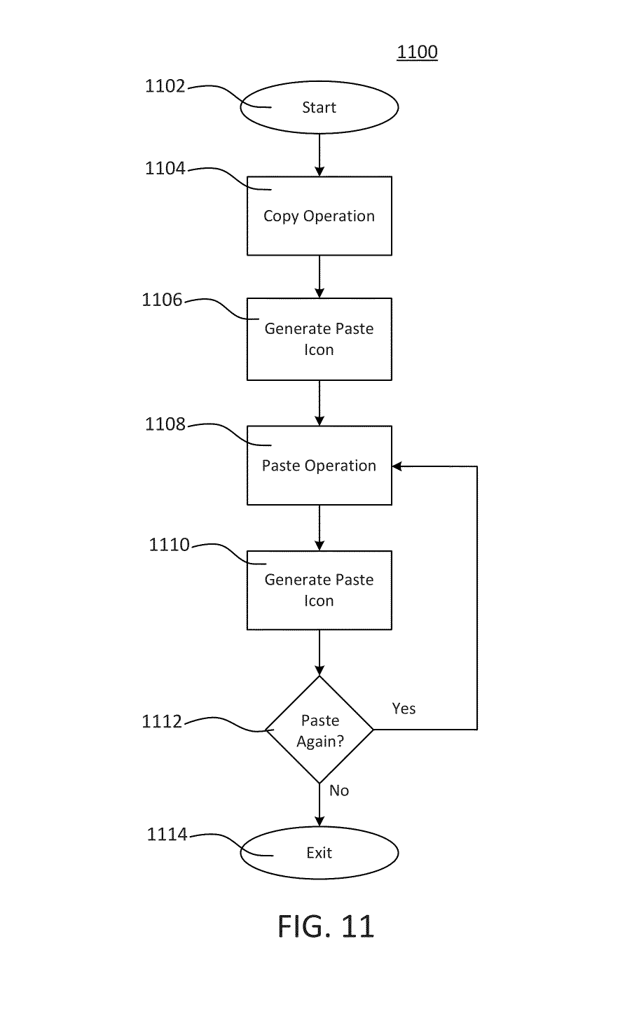

FIG. 11 is a flow chart illustrating an example single copy, multiple paste operation. The single copy, multiple paste operation may be utilized by the energy savings and cost estimation tool, for example. The single copy, multiple paste operation 1100 may start at 1102. Information, such as room information, for example, may be copied via a copy operation (e.g., a single copy operation) at 1104. The copy operation may be, for example, an activation of an icon on a screen of an electronic device. The activation of the icon may be a press and hold of the icon, for example, for a predetermined period of time. After performing the copy operation, a paste indicator (e.g., a paste icon) may be generated (e.g., automatically generated) at 1106. For example, the paste indicator may be generate and displayed at a predefined location on a screen of the electronic device (e.g., electronic device 280/902).

The information may be duplicated via a paste operation at 1108. The information may be duplicated one or more times via one or more paste operations without having to perform additional copy operations at 1104. The paste operation may be, for example, an activation of the paste indicator on the screen of the electronic device. For example, the activation of the paste indicator may be a press of a paste indicator. After performing the paste operation, another paste indicator (e.g., a paste icon) may be generated (e.g., automatically generated) at 1110. For example, the paste indicator may be generated and displayed at another predefined location on a screen of the electronic device (e.g., electronic device 280/902).

After another paste indicator is generated, the user may determine whether or not they would like to duplicate the information additional times at 1112. If the user would like to duplicate the information additional times, the additional paste operations may be performed, for example, by returning to 1108. If the user is done duplicating the information, then the single copy, multiple paste operation may be exited at 1114. For example, the single copy, multiple paste operation may be exited by deleting the most recent paste indicator generated and displayed on the screen (e.g., by actuating an “X” in the corner of the paste indicator). Therefore, information may be copied via one operation and duplicated a plurality of times via a plurality of paste operations without the need to recopy the information after each paste operation or the need to select the location of where to paste the information.

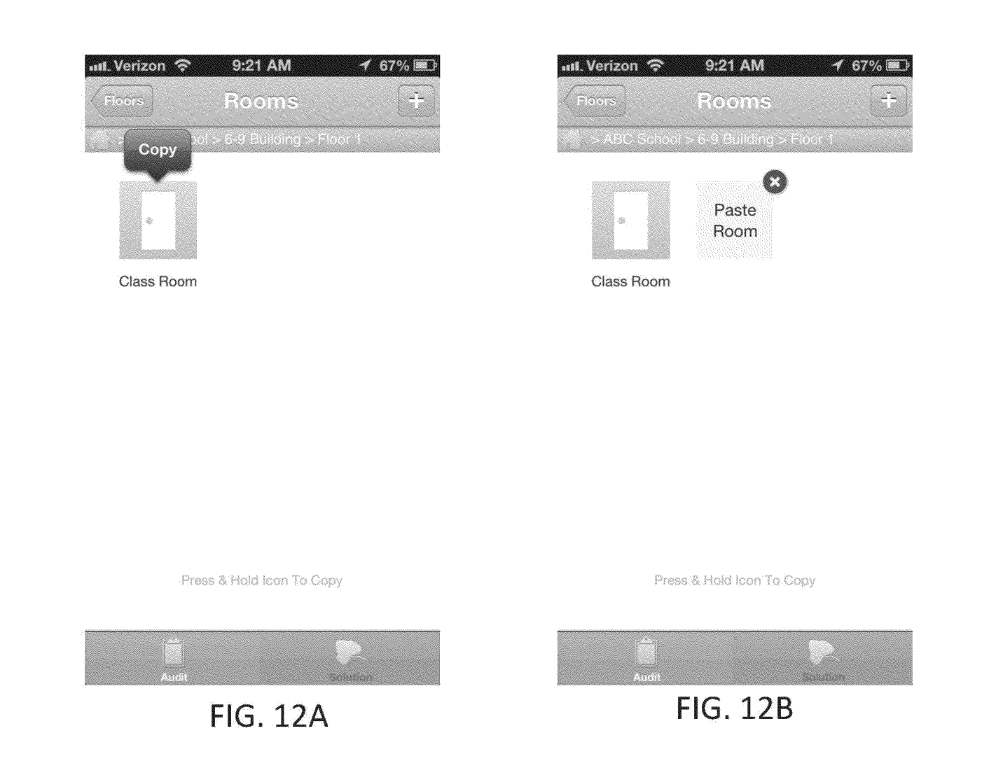

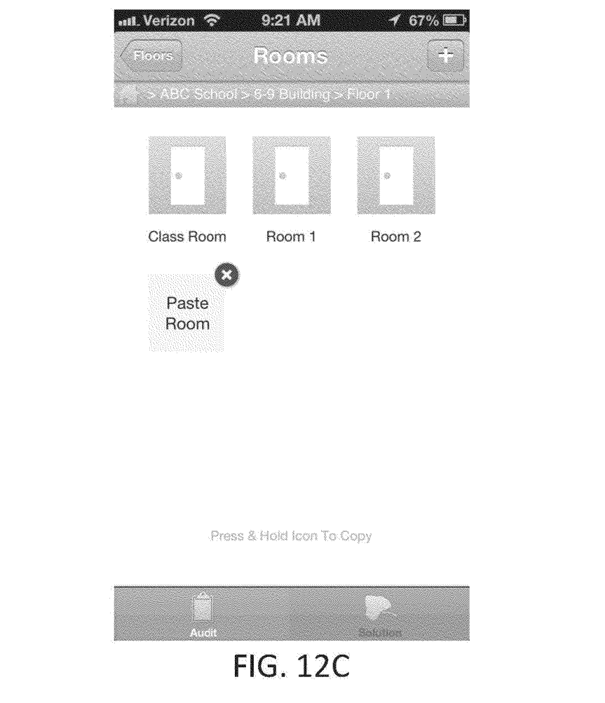

FIGS. 12A-12C are diagrams illustrating an example of a single copy, multiple paste operation. The single copy, multiple paste operation may be implemented in a mobile application, such as the energy savings and cost estimation tool, for example. A user may perform a copy operation, for example, via the press and hold of an icon (e.g., as shown in FIG. 12A) that is displayed on a screen of a mobile device. The icon may be a visual representation of information, for example, of room information. After performing the copy operation, an active paste icon may be generated and/or displayed on the electronic device (e.g., as shown in FIG. 12B). The active paste icon may represent an area on the screen where the copied information may be pasted. The active paste icon may be automatically displayed after the copy operation. The active paste icon may be displayed in a predefined location on the screen.

The user may perform a paste operation of the information (e.g., room information) by pressing the active paste icon on the screen of the electronic device. Therefore, after copying the information, the user may paste the information with a single operation, such as a single touch of the screen, for example. After performing a paste operation, a new icon representing the duplication of the information may be generated and displayed on the screen, and a second active paste icon may be generated and/or displayed on the electronic device (e.g., as shown in FIG. 12C where two paste operations were completed and a third active paste icon may be generated and/or displayed on the electronic device). The second active paste icon may represent an area on the screen where the copied information may be pasted a second time. The second active paste icon may be automatically displayed after the first paste operation. The active paste icon may be displayed in a second predefined location on the screen.

The paste operation may be continued until the user no longer desires to make addition duplications of the information. The user may duplicate the information additional times by subsequently pressing active paste icons, for example, with a single touch of the screen. When the user has duplicated the information the desired number of times, the user may end the single copy, multiple paste operation, for example, by pressing an “x” located on an active paste icon.

A single cut, multiple paste operation of information on an electronic device may include copying the information via a copy operation. The copy operation may be an actuation of an icon on the screen of the electronic device. The icon may be representative of the information. For example, the icon may be a room icon and the information may be room information. The actuation of the icon may be, for example, a press and hold of the icon.

The single cut, multiple paste operation may generate (e.g., automatically generate) a first paste icon in a first predefined location on a screen of the electronic device, for example, in response to the copy operation. The single cut, multiple paste operation may duplicate the information in the first predefined location via a first paste operation. The first paste operation may be an actuation of the first paste icon on the screen of the electronic device. The actuation of the first paste icon may be, for example, a press and hold of the first paste icon. The single cut, multiple paste operation may generate (e.g., automatically generate) a second icon representative of the information in the first predefined location in response to the first paste operation.

The single cut, multiple paste operation may generate (e.g., automatically generate) a second paste icon in a second predefined location on the screen of the electronic device, for example, in response to the first paste operation. The single cut, multiple paste operation may delete the second paste icon to exit the single cut, multiple paste operation. The single cut, multiple paste operation may duplicate the information in the second predefined location via a second paste operation. The second paste operation may be an actuation of the second paste icon on the screen of the electronic device. The actuation of the second paste icon may be, for example, a press and hold of the second paste icon. The single cut, multiple paste operation may generate (e.g., automatically generate) a third icon representative of the information in the second predefined location in response to the second paste operation. The single cut, multiple paste operation may generate (e.g., automatically generate) a third paste icon in a third predefined location on the screen of the electronic device in response to the second paste operation. The single cut, multiple paste operation may duplicate the information a plurality of times before the operation is exited. The single cut, multiple paste operation may delete the third paste icon to exit the single cut, multiple paste operation.

Although described with reference to a lighting project, and a lighting retrofit project specifically, the energy saving and cost estimation tool may be used to generate projects and solutions outside of the lighting and lighting energy field. For example, the project (and solution) may include one or more of lighting and lighting controls, shade and shade controls, HVAC systems, security systems, entertainment systems, etc.

Embodiments, such as the energy saving and cost estimation tool, for example, may take the form of a tangible and/or non-transitory computer-usable or computer-readable storage medium capable storing program code for use by or in connection with a computer or any instruction execution system. Examples of a computer-usable or computer-readable medium include tangible computer media such as semiconductor or solid state memory, magnetic tape, a removable computer diskette, a random access memory (RAM), a read-only memory (ROM), a rigid magnetic disk and an optical disk, for example. Current examples of optical disks include compact disk - read only memory (CD-ROM), compact disk--read/write (CD-R/W) and DVD, for example. A processor may be configured to execute instructions stored in memory to perform the various functions described herein.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A method of generating a lighting solution for a current project, the method comprising:
generating a project profile associated with the current project;
retrieving existing project information associated with one or more existing projects from a database;
generating an assumption associated with the current project using the project profile and the existing project information; and
generating a lighting strategy for the current project using the project profile and the assumption, the lighting strategy characterized by one or more of a fixture type, a lamp type, a sensor type, and a control type; and
generating the lighting solution for the project using the lighting strategy and the project profile.

2. The method of claim 1, wherein the project profile comprises one or more of a project type, a total number of buildings of the project, a total yearly operating hours of the project, a number of floors per building of the project, a number of rooms per floor of the project, a room type for a room of the project, a size of a room of the project, whether a room has windows, a number of zones per room of the project, an existing fixture, an existing lighting control, an existing sensor, and heating, ventilating, and air conditioning (HVAC) information.

3. The method of claim 2, wherein the project type is one of a commercial office, an educational building, a hospitality building, a healthcare building, or a sporting venue.

4. The method of claim 1, wherein the existing project information comprises one or more of energy usage of an existing project, a total number of buildings of an existing project, a total yearly operating hours of an existing project, a number of floors per building of an existing project, a number of rooms per floor of an existing project, a room type for a room of an existing project, a size of a room of an existing project, whether a room has windows, a number of zones per room of an existing project, a fixture of an existing, a lighting control of an existing, a sensor of an existing, and heating, ventilating, and air conditioning (HVAC) information of an existing project.

5. The method of claim 1, wherein the assumption is characterized by energy usage of the current project.

6. The method of claim 1, wherein the lighting solution comprises one or more of the lighting strategy, a bill of material (BOM), an implementation cost, a return on investment metric for the project, and energy savings.

7. The method of claim 1, further comprising:
defining an implementation cost for the current project, a return on investment metric for the current project, or an energy savings for the current project; and
generating the lighting solution for the current project according to the cost estimate, the return on investment metric, or the energy savings.

8. The method of claim 1, wherein determining the lighting solution for the current project comprises:
generating a baseline energy profile associated with the current project based on the project profile;
generating a proposed energy profile associated with the current project based on the lighting strategy and the baseline energy profile; and
generating the lighting solution for the current project using the proposed energy profile.

9. The method of claim 1, further comprising:
redefining the project profile associated with the current project;
generating a second assumption associated with the current project using the redefined project profile and the existing project information; and
generating a second lighting solution for the current project using the redefined project profile, the existing project information, and the second assumption.

10. The method of claim 1, further comprising:
receiving override input data associated with the assumption;
generating a second lighting strategy for the current project using the project profile and the override input data; and
generating a second lighting solution for the current project using the second lighting strategy and the project profile.

11. The method of claim 1, further comprising:
displaying the solution on a screen of a mobile device.

12. A method for generating a lighting solution for a current project, the method comprising:
generating a project profile associated with the current project;
retrieving existing project information associated with one or more existing projects from a database;
generating a baseline energy profile for the current project based on the project profile and the existing project information, wherein the baseline energy profile comprises energy usage information for the current project;
determining a proposed lighting strategy for the current project, the proposed lighting strategy being characterized by one or more of a fixture type, a lamp type, a sensor type, and a control type; and
generating a proposed energy profile for the current project based on the project profile, the baseline energy profile, and the proposed lighting strategy.

13. The method of claim 12, wherein the proposed energy profile comprises energy usage information associated with the current project and the proposed lighting strategy.

14. The method of claim 12, further comprising:
defining a plurality of discrete time periods relating to energy usage in connection with the current project;
wherein the baseline energy profile and the proposed energy profile comprise energy usage information for each of the plurality of discrete time periods.

15. The method of claim 12, wherein the plurality of discrete time periods comprises a business hours with daylight period, a business hours without daylight period, an afterhours with daylight period, and an afterhours without daylight period.

16. The method of claim 12, further comprising:
generating a lighting solution for the current project using the project profile, the baseline energy profile, the proposed lighting strategy, and the proposed energy profile.

17. The method of claim 16, wherein the solution comprises one or more of the proposed lighting strategy, a bill of material (BOM), an implementation cost, a return on investment metric, and energy savings.

18. The method of claim 17, wherein the BOM is generated according to the proposed lighting strategy and product information from the database;
wherein the implementation cost is generated according to labor information from the database and the BOM;
wherein the energy savings is generated according to the baseline energy profile, the proposed energy profile, and the proposed lighting strategy; and
wherein the return on investment metric is generated according to the energy savings, the implementation cost, and energy pricing information from the database.

19. The method of claim 14, further comprising:
generating an assumption associated with the current project based on the project profile and the existing project information, wherein the assumption relates to energy usage during a time period of the plurality of discrete time periods.

20. The method of claim 19, wherein the assumption relates to energy usage of a room of the current project during the time period; and
wherein the assumption is generated using energy usage information of an existing room of an existing project retrieved from the database.

21. The method of claim 20, wherein the room of the current project and the existing room of the existing project are a same room type; and
wherein the energy usage of the room of the current project and the energy usage of the existing room of the existing project relate to the same time period.

22. The method of claim 12, wherein the project profile comprises one or more of a project type, a total number of buildings of the project, a total yearly operating hours of the project, a number of floors per building of the project, a number of rooms per floor of the project, a room type for a room of the project, a size of a room of the project, whether a room has windows, a number of zones per room of the project, an existing fixture, an existing lighting control, an existing sensor, and heating, ventilating, and air conditioning (HVAC) information.

23. A method for generating a lighting solution for a current project, the method comprising:
generating a project profile associated with the current project, the current project comprising a plurality of rooms and the project profile comprising a room type for each of the plurality of rooms;
retrieving existing project information associated with energy usage of a plurality of existing rooms of one or more existing projects from a database;
generating a plurality of assumptions associated with energy usage of each of the plurality of rooms of the current project based on the project profile and the existing project information; and
generating a lighting strategy for each of the plurality of rooms of the current project using the plurality of assumptions and the project profile.

24. The method of claim 23, wherein each of the plurality of assumptions is generated for each of the plurality of rooms of the current project using energy usage of an existing room of the plurality of existing rooms of the same room type.

25. The method of claim 23, further comprising:
defining a plurality of discrete time periods associated with energy usage in connection with the current project; and
wherein each of the plurality of assumptions relates to a time period of the plurality of discrete time periods.

26. The method of claim 23, wherein the lighting strategy for each of the plurality of rooms is characterized by one or more of a fixture type, a lamp type, a sensor type, and a control type.

27. The method of claim 23, further comprising:
generating a lighting solution for the current project using the lighting strategy for each of the plurality of rooms.

28. The method of claim 27, wherein the lighting solution comprises the lighting strategy for each of the plurality of rooms of the current project and one or more of a bill of material (BOM), an implementation cost, a return on investment metric, and energy savings.

29. A computer-readable storage medium comprising computer-executable instructions for implementing a method of generating a lighting solution for a current project, the method comprising:
generating a project profile associated with the current project;
retrieving existing project information associated with one or more existing projects from a database;
generating an assumption associated with the current project using the project profile and the existing project information; and
generating a lighting strategy for the current project using the project profile and the assumption, the lighting strategy characterized by one or more of a fixture type, a lamp type, a sensor type, and a control type; and
generating the lighting solution for the project using the lighting strategy and the project profile.

30. The computer-readable storage medium of claim 29, wherein the project profile comprises one or more of a project type, a total number of buildings of the project, a total yearly operating hours of the project, a number of floors per building of the project, a number of rooms per floor of the project, a room type for a room of the project, a size of a room of the project, whether a room has windows, a number of zones per room of the project, an existing fixture, an existing lighting control, an existing sensor, and heating, ventilating, and air conditioning (HVAC) information.

31. The computer-readable storage medium of claim 30, wherein the project type is one of a commercial office, an educational building, a hospitality building, a healthcare building, or a sporting venue.

32. The computer-readable storage medium of claim 29, wherein the existing project information comprises one or more of energy usage of an existing project, a total number of buildings of an existing project, a total yearly operating hours of an existing project, a number of floors per building of an existing project, a number of rooms per floor of an existing project, a room type for a room of an existing project, a size of a room of an existing project, whether a room has windows, a number of zones per room of an existing project, a fixture of an existing, a lighting control of an existing, a sensor of an existing, and heating, ventilating, and air conditioning (HVAC) information of an existing project.

33. The computer-readable storage medium of claim 29, wherein the assumption is characterized by energy usage of the current project.

34. The computer-readable storage medium of claim 29, wherein the lighting solution comprises one or more of the lighting strategy, a bill of material (BOM), an implementation cost, a return on investment metric for the project, and energy savings.

35. The computer-readable storage medium of claim 29, the method further comprising:
defining an implementation cost for the current project, a return on investment metric for the current project, or an energy savings for the current project; and
generating the lighting solution for the current project according to the cost estimate, the return on investment metric, or the energy savings.

36. The computer-readable storage medium of claim 29, wherein determining the lighting solution for the current project comprises:
generating a baseline energy profile associated with the current project based on the project profile;
generating a proposed energy profile associated with the current project based on the lighting strategy and the baseline energy profile; and
generating the lighting solution for the current project using the proposed energy profile.

37. The computer-readable storage medium of claim 29, the method further comprising:
redefining the project profile associated with the current project;
generating a second assumption associated with the current project using the redefined project profile and the existing project information; and
generating a second lighting solution for the current project using the redefined project profile, the existing project information, and the second assumption.

38. The computer-readable storage medium of claim 29, the method further comprising:
receiving override input data associated with the assumption;
generating a second lighting strategy for the current project using the project profile and the override input data; and
generating a second lighting solution for the current project using the second lighting strategy and the project profile.

39. The computer-readable storage medium of claim 29, the method further comprising:
displaying the solution on a screen of a mobile device.

40. A system for generating a lighting solution for a current project, the system comprising:
a processor configured to:
generate a project profile associated with the current project;
retrieve existing project information associated with one or more existing projects from a database;
generate an assumption associated with the current project using the project profile and the existing project information; and
generate a lighting strategy for the current project using the project profile and the assumption, the lighting strategy characterized by one or more of a fixture type, a lamp type, a sensor type, and a control type; and
generate the lighting solution for the project using the lighting strategy and the project profile.

41. The system of claim 40, wherein the project profile comprises one or more of a project type, a total number of buildings of the project, a total yearly operating hours of the project, a number of floors per building of the project, a number of rooms per floor of the project, a room type for a room of the project, a size of a room of the project, whether a room has windows, a number of zones per room of the project, an existing fixture, an existing lighting control, an existing sensor, and heating, ventilating, and air conditioning (HVAC) information.

42. The system of claim 41, wherein the project type is one of a commercial office, an educational building, a hospitality building, a healthcare building, or a sporting venue.

43. The system of claim 40, wherein the existing project information comprises one or more of energy usage of an existing project, a total number of buildings of an existing project, a total yearly operating hours of an existing project, a number of floors per building of an existing project, a number of rooms per floor of an existing project, a room type for a room of an existing project, a size of a room of an existing project, whether a room has windows, a number of zones per room of an existing project, a fixture of an existing, a lighting control of an existing, a sensor of an existing, and heating, ventilating, and air conditioning (HVAC) information of an existing project.

44. The system of claim 40, wherein the assumption is characterized by energy usage of the current project.

45. The system of claim 40, wherein the lighting solution comprises one or more of the lighting strategy, a bill of material (BOM), an implementation cost, a return on investment metric for the project, and energy savings.

46. The system of claim 40, wherein the processor is further configured to:
define an implementation cost for the current project, a return on investment metric for the current project, or an energy savings for the current project; and
generate the lighting solution for the current project according to the cost estimate, the return on investment metric, or the energy savings.

47. The system of claim 40, wherein the processor configured to determine the lighting solution for the current project comprises:
the processor configured to:
generate a baseline energy profile associated with the current project based on the project profile;
generate a proposed energy profile associated with the current project based on the lighting strategy and the baseline energy profile; and
generate the lighting solution for the current project using the proposed energy profile.

48. The system of claim 40, wherein the processor is further configured to:
redefine the project profile associated with the current project;
generate a second assumption associated with the current project using the redefined project profile and the existing project information; and
generate a second lighting solution for the current project using the redefined project profile, the existing project information, and the second assumption.

49. The system of claim 40, wherein the processor is further configured to:
receive override input data associated with the assumption;
generate a second lighting strategy for the current project using the project profile and the override input data; and
generate a second lighting solution for the current project using the second lighting strategy and the project profile.

50. The system of claim 40, wherein the processor is further configured to:
display the solution on a screen of a mobile device.
